(19) United States
(12) Patent Application Publication
(10) Pub. No.: US 2014/0025461 A1
(43) Pub. Date: Jan. 23, 2014

(54) ENHANCED TRANSACTION PROCESSING

(71) Applicant: FIRST DATA CORPORATION, Atlanta, GA (US)

(72) Inventors: Kevin Joseph Knowles, Highlands Ranch, CO (US); Sarah Owen, Atlanta, GA (US); Julie Christine Bohn, Omaha, NE (US); Robert James Cole, Maysville, GA (US); Sammy Leigh Coleman, Hagerstown, MD (US); Peter R. Cavicchi, III, Coral Springs, FL (US); Susan Munn Young, Nashville, TN (US); Amy Lynne Kirshenbaum, Denver, CO (US)

(73) Assignee: FIRST DATA CORPORATION, Atlanta, GA (US)

(21) Appl. No.: 13/629,229

(22) Filed: Sep. 27, 2012

Related U.S. Application Data
(63) Continuation of application No. 13/554,848, filed on Jul. 20, 2012, now abandoned.

(51) Int. Cl. G06Q 30/02; G06Q 20/40

(52) U.S. Cl. 705/14.23; 705/14.51

(57) ABSTRACT

Methods, systems, and computer-executable instructions for processing financial transactions are provided. An exemplary method includes receiving a request from a merchant to authorize payment for a transaction using a financial account of a customer. The request includes information about the transaction. The method further includes analyzing the transaction information based on a profile of the customer that is linked to the financial account and based on data pertaining to at least one other related transaction. Finally, the method includes generating a message about the transaction based on the analysis and transmitting the message to a recipient.

### RELATED APPLICATIONS

This application is a continuation of U.S. patent application Ser. No. 13/554,848, entitled “ENHANCED TRANSACTION PROCESSING,” which was filed Jul. 20, 2012, and claims priority to U.S. Provisional Patent Application No. 61/510,921, entitled “PERSONALIZED MARKETING,” which was filed on Jul. 22, 2011, the contents of which are incorporated by reference in their entirety herein.

### TECHNICAL FIELD

Various embodiments of the present application generally relate to the field of computer-based processing of financial transactions. More specifically, various embodiments of the present application relate to enhanced features of transaction processing and promotion redemption.

### BACKGROUND

An increasing number of financial transactions are performed using credit cards, debit cards, and electronic payments. When a customer provides a payment to a merchant for a purchase using one of these payment methods, the payment is often processed by a third party, often referred to as a payment processor. Payment processors typically have connections to various card associations and provide payment processing and settlement services for customers, merchants, and merchant banks associated with transactions. In addition, the payment processor may perform other functions associated with transactions including account verification and fraud detection. A merchant receiving a credit or debit card as payment typically transmits an authorization request to the payment processor. The payment processor performs various steps to verify the transaction and transmits an authorization back to the merchant if the transaction is approved. The merchant then completes the transaction with the customer and the accounts of the merchant and the customer are settled accordingly.

In managing their personal finances, customers must keep track of large quantities of information. The electronic era has given customers more options for managing their personal finances and has also increased the amount of information customers are exposed to and must keep track of. The electronic era has also heightened customer expectations regarding capabilities to complete transactions electronically, automated linking of pertinent financial data, and automated recordkeeping. Customers desire simplified methods of performing transactions and more automated methods of managing information associated with those transactions. Customers also desire improved methods of tracking and managing information associated with their personal finances.

Merchants have similar desires to automate transactions and simplify recordkeeping in order to reduce costs, reduce fraud, and make the best possible use of information they have about their customers. Merchants often use many different types of promotions and discount offers in order to increase business, increase familiarity with or exposure to their products or services, and/or reward loyal customers. In many cases, promotions are operated in the form of a coupon or other documentation which a customer must provide to the merchant in order to take advantage of the promotion. In other cases, the customer must provide some other type of code or documentation in order to redeem a promotion. Promotions may be provided in many forms including a fixed percentage discount, a discounted price on a specific product, buy one get one free, a free item or service, a credit for a fixed amount, or other formats. While these various types of promotions may accomplish the intended objectives of the merchant, they also sometimes lead to reductions in profit margin and even losses on particular transactions in some cases. Merchants are therefore interested in maximizing the benefits associated with these types of promotions, while minimizing costs and maintaining control over the use of promotions.

In conjunction with the trends described above, a specialized industry of promotion providers has developed. These promotion entities utilize various means, including electronic means, to provide promotion services for manufacturers and merchants. This industry includes promotion marketers, promotion distributors, and promotion processors. Like merchants, these entities have an interest in automating transaction and promotion processing. Automating these processes with respect to promotions provides many benefits including reduced costs, reduced fraud, increased marketing advantages, increased targeted marketing capabilities, and improved customer satisfaction.

### SUMMARY

Methods, systems, computer executable instructions, and devices for providing enhanced transaction processing features are provided. These enhanced transaction processing features improve the capabilities of transaction and promotion processing by providing automated promotion processing, multiple account linking, automated transaction notifications, promotion management tools, and interfaces to other financial systems and environments.

In one exemplary embodiment of the present invention, a method for processing financial transactions includes receiving a request from a merchant to authorize payment for a transaction using a financial account of a customer. The request includes information about the transaction. The method further includes analyzing the transaction information based on a profile of the customer that is linked to the financial account and based on data pertaining to at least one other related transaction. Finally, the method includes generating a message about the transaction based on the analysis and transmitting the message to a recipient.

In one variation of the invention, the profile indicates membership of the customer in a coalition of customers. The related transaction is a transaction of another customer that belongs to the coalition and the recipient is at least one of the customers of the coalition.

In another variation of the invention, the transmitted message includes aggregated transaction information of multiple customers of the coalition.

In another variation of the invention, the message includes information indicating progress toward an objective of the coalition of customers.

In another variation of the invention, the transmitted message includes a promotion, a discount, or an offer directed to the coalition of customers.

In one exemplary embodiment of the invention, the profile identifies a group of merchants authorized to receive information about transactions of the customer and the message is transmitted to a merchant of the group.

One variation of the embodiment above includes receiving information from the customer authorizing merchants to be in the group of merchants and updating the profile based on the received information.

In another variation, the merchants of the group are providers of complementary products and the message includes information about one or more items in the transaction.

In some embodiments of the invention, the transaction includes redemption of a promotion. In this case, the related transaction is a transaction associated with purchase of the promotion and the message includes an indication of the redemption of the promotion.

In some embodiments, the recipient of the message is a provider of the promotion, a publisher of the promotion, a marketer of the promotion, and/or the merchant.

In some embodiments, the transmitted message further includes a metric associated with the redemption of the promotion.

In some cases, the metric associated with the redemption of the promotion may include the amount of time elapsed between the purchase of the promotion and the redemption, a comparison of an amount of the transaction compared to amounts of other transactions of the customer, a comparison of the amount of the transaction to amounts of redemption transactions for the promotion associated with other customers, and/or a comparison of characteristics of the redemption to redemptions of other promotions.

In one variation of the embodiments above, the transmitted message may include predictive analytics of customer behavior based on the performed analysis.

In another variation of the invention, the profile includes monitored transaction characteristics and the analysis of the transaction information based on the profile includes determining that the transaction includes one of the monitored transaction characteristics.

In a further variation of the invention, the monitored transaction characteristics are related to an item included in the transaction, a category of items associated with the transaction, an amount of the transaction, the merchant, and/or a category of merchant associated with the transaction.

In a further variation of the invention, the monitored transaction characteristics are specified by a government agency and the government agency is the recipient of the message.

In one exemplary embodiment of the invention, the related transaction is a transaction conducted using another account of the customer and the profile includes information linking the account and the other account of the customer.

In some embodiments, the customer is the recipient of the message and the message includes a promotion, an offer, or a discount related to the transaction.

While multiple additional embodiments are discussed and disclosed, still other embodiments of the present invention will become apparent to those skilled in the art from the following detailed description and figures, which show and describe illustrative embodiments of the invention. As will be realized, the invention is capable of modifications in various aspects, all without departing from the scope of the present invention. Accordingly, the drawings and detailed description are to be regarded as illustrative in nature and not restrictive or limiting.

### BRIEF DESCRIPTION OF THE DRAWINGS

Embodiments of the present invention will be described and explained through the use of the accompanying figures.

FIG. 1 illustrates an example of an operating environment in which some embodiments of the present invention may be utilized.

FIG. 2 illustrates a method of operating a transaction processing system to process a transaction that includes a discount.

FIG. 3 illustrates an example of an operating environment in which some embodiments of the present invention may be utilized.

FIG. 4 illustrates a method of post-processing settlement of promotion discounts.

FIG. 5 illustrates a method of processing purchase and redemption of an offer utilizing a redemption account.

FIG. 6 illustrates an offer redemption process in which an offer provider is actively involved in the redemption process.

FIG. 7 illustrates a method of processing promotions with a customer supplied promotion identifier.

FIG. 8 illustrates a method of adjusting a transaction based on a promotion.

FIG. 9 illustrates a method of processing a promotion in conjunction with a prepaid account.

FIG. 10 illustrates a method of adjusting a transaction based on a promotion.

FIG. 11 illustrates a payment processing system.

FIG. 12 illustrates a computer system with which some embodiments of the present invention may be utilized.

Some components and/or operations may be separated into different blocks or combined into a single block for the purposes of discussion of some of the embodiments of the present invention. Similarly, the drawings have not necessarily been drawn to scale. For example, the dimensions of some of the elements in the figures may be expanded or reduced to help improve the understanding of the embodiments of the present invention. Moreover, while the invention is amenable to various modifications and alternative forms, specific embodiments have been shown by way of example in the drawings and are described in detail below. The intention, however, is not to limit the invention to the particular embodiments or implementations described. On the contrary, the invention is intended to cover all modifications, equivalents, and alternatives falling within the scope of the invention as defined by the appended claims.

### DETAILED DESCRIPTION

Various embodiments of the present application generally relate to the field of processing financial transactions. More specifically, various embodiments of the present application relate to enhanced features for payment processing that include, in some cases, promotion redemption and processing. The embodiments below are primarily described from the perspective of a credit/debit/prepaid card processing system, server, or entity. The intention, however, is not to limit the invention to implementation by a credit/debit/prepaid card processor. On the contrary, the invention is intended to cover all implementations falling within the scope of the invention as defined by the appended claims. In the following description, for the purposes of explanation, numerous specific details are set forth in order to provide a thorough understanding of embodiments of the present invention. It will be apparent, however, to one skilled in the art that embodiments of the present invention may be practiced without some of these specific details.

In one embodiment of the present invention, a transaction processing system is capable of providing automated processing of promotions and discounts. The promotions and discount may be automatically applied to a transaction by the transaction processor without the customer or merchant providing any additional information or identification of the promotion or discount. The customer provides only the card or account number being used to pay for the transaction. The promotion or discount may be associated with the customer account in various ways including: purchase of the promotion or discount by the customer using the same card or account number, attachment of the promotion or discount to the account by the customer in another manner, or attachment of the promotion or discount to the account by another party. Adjustments to the transaction to reflect the promotion or discount may be made in real time during the transaction processing or may be settled in post processing after the transaction has been completed. Centralized tracking of promotions and discounts and association with customer accounts enables other enhanced features including transferring of promotions or discounts from one customer account to another.

In another embodiment, a unique account identifier or suffix is assigned to one or more customer accounts. The unique identifier or suffix enables information about customers, customer behaviors, promotions, redemptions, or other transaction information to be shared with merchants and providers without disclosing the account number or card number. In a variation of this embodiment, the unique identifier may be used to identify and link transactions or activities of multiple accounts of the customer. In another variation of this embodiment, promotions or discounts may also be associated with the unique identifier for simplified redemption and tracking of promotions. In yet another variation, a customer can access a single centralized account to access and manage promotions that may originate from multiple different promoters, publishers, advertisers, or merchants. These various promotions may be associated with different accounts of the customer and are linked using a unique identifier that also links the multiple payment accounts.

In another embodiment of the invention, the enhanced features and benefits of the transaction processing system may be extended to other payment or transaction environments not typically associated with debit or credit cards by linking those transactions with the transaction processing system. For example, the additional benefits of the transaction processing system described herein may be extended to various other types of transactions including person-to-person (P2P) transactions, direct bank account transfers, transactions in virtual environments, and transactions including non-traditional currencies. The system may also track customer activities or behaviors in these other environments. Information resulting from this tracking may be used to generate targeted offers or to reward customer behavior in these other environments through additional promotions or discounts.

In another embodiment of the invention, an enhanced transaction processing system provides additional promotion management features. In some cases, these additional features may include electronic loading and redemption of promotions or coupons that were not originally in electronic form or were not automatically attached to a customer account. In addition, the transaction processing system may be configured to select from among multiple potentially applicable promotions at the time of processing of a transaction. The selection process may include determining the best available offer or discount for a transaction. The selection may be further based on customer supplied parameters. The system may also enable promotion providers, publishers, or other entities to bid or otherwise provide competing submissions for a transaction on a real-time basis.

In another embodiment of the invention, the transaction processing methods described herein may be used to track customer behavior across multiple accounts or to track behavior of groups or coalitions of customers. This information may be used by merchants, marketers, offer publishers, or offer providers to analyze customer responses to promotions and customer behaviors with respect to promotion redemption. Results of the analysis can be used to generate improved promotions and to identify targets for those offers and promotions. These tracking features may also be used for providing real-time or near real-time transaction notifications to the customer and/or to any third party. These notifications may include notification of: potential fraud, questionable transactions, transactions involving specified categories of products or services, transactions with amounts meeting specified criteria, transactions at specified merchants or types of merchants, or transactions occurring within designated geographies or timeframes. In addition, the notifications may be related to account status or progress toward a target or objective. Any of these notifications may pertain to an individual customer, an individual account, a group of accounts, or a group or coalition of customers.

In another embodiment of the invention, the transaction processing system may be utilized to perform other processing functions associated with a transaction in conjunction with the payment processing. These other processing functions may relate to an interest or role of a third party in the transaction.

In conjunction with the various embodiments of the invention described above, additional tools are provided for making further beneficial use of the invention. In one example, a merchant lookup tool is provided for electronically determining which merchants participate in and/or are capable of utilizing the various enhanced features of the system. In another example, the system includes rate tables designating rates charged to various promotion entities for use of the system features and automated billing to those entities based on their use of the features.

In another embodiment of the invention, the transaction processing system implements promotions and discounts using prepaid accounts. A promotion or discount may be offered in the form of a prepaid account or a prepaid card. When created, the prepaid account is associated with a product or category of products in a centralized database. When the prepaid account is redeemed by the customer, the prepaid account and information about the product it is being used for are sent to the transaction processor. The transaction processor verifies that the product being purchased is a product or category of product for which the promotion was originally intended. In this way, merchants are able to maintain control over which products a discount will be applied to and maintain control over the number of instances and redemptions of promotions.

In another embodiment of the invention, a method of increasing customer traffic at merchants is provided. The method involves creating a targeted offer for customers based on preexisting purchase behavior data about the customers. The targeted offer requires a customer to purchase the offer and entitles the customer to a discount on the product or service. The method further includes accumulating analytical information relating to purchase of the offer for reporting offer participation metrics. The offer participation metrics may include metrics related to purchase of the offer, redemption of the offer, and subsequent patronization of the merchant by the customer who purchased the offer.

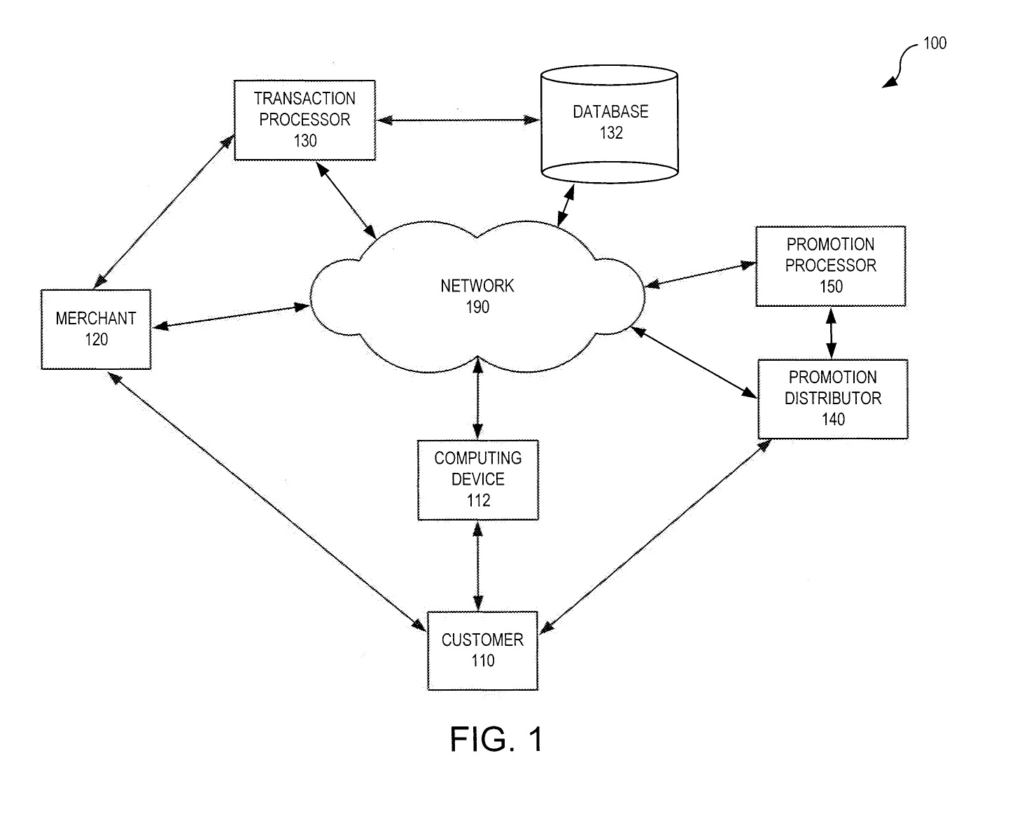

Having described embodiments of the present invention generally, attention is directed to FIG. 1 which illustrates operating environment 100 in which some embodiments of the present invention may be utilized. Operating environment 100 includes customer 110, computing device 112, merchant 120, transaction processor 130, database 132, promotion processor 150, promotion distributor 140, and network 190.

Customer 110 is any party who may perform a transaction at merchant 120 using a credit card, a debit card, a prepaid card, or any form of payment other than cash. Customer 110 may be an individual, a business, a corporation, a government, or any other entity. Merchant 120 is any provider of goods or services. Merchant 120 may be an online merchant or a bricks-and-mortar merchant. Customer 110 may engage in transactions directly with merchant 120 by visiting a location of merchant 120 and conducting a transaction in person or by interacting with merchant 120 electronically using computing device 112. Computing device 112 may communicate with merchant 120 directly or through one or more networks such as network 190 or through other devices, systems, or networks. Computing device 112 is any type of computing mechanism or electronic device which enables customer 110 to enter data to conduct a transaction. Computing device 112 may be a personal computer, server, Internet terminal, kiosk, set top box, wireless phone, smartphone, wireless computer, personal digital assistant (PDA), tablet, or transportable computing device. Computing device 112 may operationally connect to network 190 through wired or wireless means.

Transaction processor 130 is any entity or system that facilitates financial transaction processing. Transaction processor 130 may be a credit card processor, a debit card processor, a payment processor, a bank, a lender, an account verification service, or other entity which handles processing of payments made by customer 110 for products or services of merchant 120. In a typical credit card transaction, customer 110 provides a credit card or account number to merchant 120 either directly or through network 190. Merchant 120 transmits an approval request to transaction processor 130 to verify that customer 110's account has sufficient credit or funds to satisfy the transaction. If so, transaction processor 130 provides merchant 120 an authorization, authorization code, or other type of approval for the transaction. Communications between merchant 120 and transaction processor 130 may occur through a direct connection or may occur through network 190, another network, or a combination of networks.

Transaction processor 130 retrieves account information from database 132 and stores transaction information in database 132. Database 132 may be any type of data storage system. The components of database 132 may include a disk drive, optical disk, flash memory, solid state memory, tape drive, or other device for storing digital data, including combinations thereof. Transaction processor 130 may also store information in database 132 relating to customers, credit accounts, debit accounts, prepaid accounts, transactions, discounts, offers, promotions, or other information relating to customers or financial transactions.

Promotion distributor 140 is any entity or system that generates, markets, publishes, or distributes promotions or offers. Promotion distributor 140 may communicate these promotions and offers to customer 110, and other customers, in both electronic and non-electronic forms. The promotions and offers may be traditional coupons and discounts or may be ‘daily deal’ type promotions that require customer 110 to purchase the promotion. Purchase of the promotion may require some type of upfront payment in order for a benefit associated with the promotion to be realized at a later time. Promotion distributor 140 may distribute or advertise promotions to customer 110 in many ways including print advertisements, television and radio commercials, web page advertising, promotion in conjunction with an Internet search engine, telemarketing, email, text messages, or using other known advertising or marketing channels. In some cases, the functions of promotion distributor 140 may be performed by another entity including merchant 120, promotion processor 150, or transaction processor 130.

Promotion processor 150 is any entity or system that assists in the processing of purchases or redemptions of promotions. Promotion processor 150 may perform functions including tracking promotion details, processing purchases of promotions, maintaining information associating promotions with customer 110, verifying promotion availability, matching transactions to promotion redemptions, and performing analytics associated with promotions and redemptions. Promotion processor 150 and promotion distributor 140 may be the same entity in some cases. In addition, the functions of promotion distributor 140 may be performed by another entity including merchant 120 or transaction processor 130.

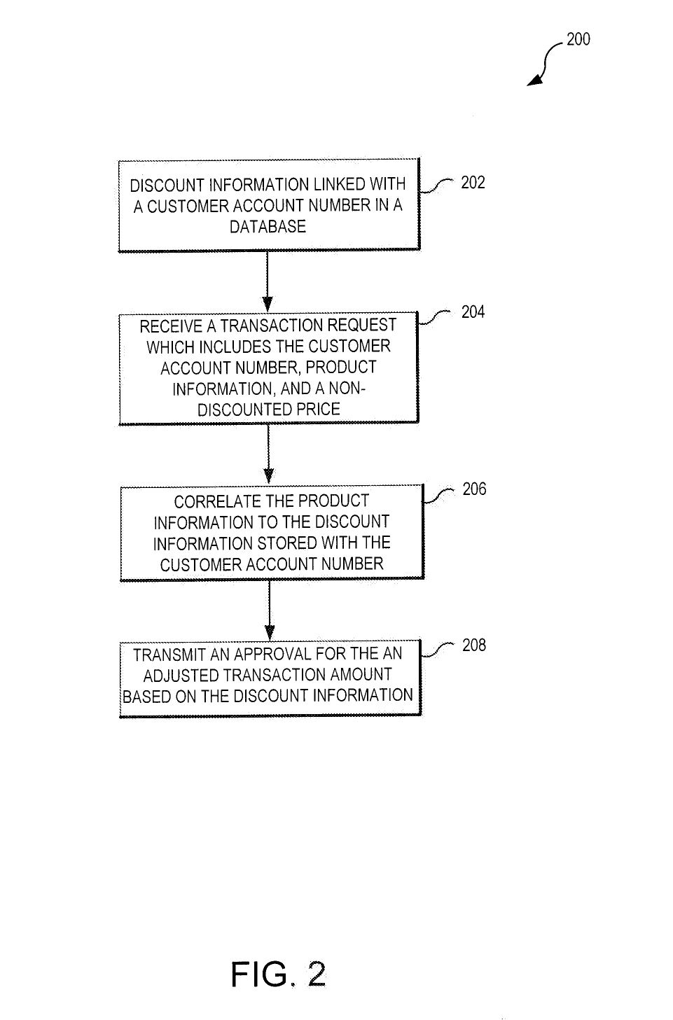

FIG. 2 illustrates method 200 of processing a transaction that includes a discount. Method 200 is described with respect to implementation in operating environment 100 and may also be implemented in other operating environments. At step 202, discount information is linked with a customer account of customer 110. The discount information is linked to the customer account by establishing a relationship between the discount information and the customer account in database 132. Many different methods of linking or associating this information are known in the data processing field and this invention is not to be limited to any particular method of linking or associating this information. The discount may be a discount offered to customer 110 at no cost to customer 110 or with no commitment from customer 110. The discount may also be a discount requiring pre-purchase by customer 110.

The case of a pre-purchased discount may be illustrated by a simple example involving a promotion for a manicure. In this example, the promotion is a discount offer providing the customer a manicure normally priced at $45 for $25. The customer is required to pre-purchase the offer by paying the $25 in advance of receiving the manicure. In many cases, the customer will become aware of the promotion through the Internet or an email message. The customer makes the purchase online using a credit card account number, but will not redeem the offer at a salon associated with the offer until some point later in time. At step 202 of FIG. 2, information about the discount is associated with the customer 110's credit card, the credit card used to purchase the promotion, in database 132. The discount information may be stored in many different manners such that it can correlated to one or more customer accounts, card numbers, or sub-accounts within an account.

At a later point in time, the customer redeems the offer by going to the salon to get the manicure. At step 204, a transaction request is received at transaction processor 130 when the customer offers the credit card for payment for the manicure. The transaction request includes the customer account number and the non-discounted price of the manicure, $45. In other words, the customer is at merchant 120, the salon, and the transaction is proceeding for the full price of the manicure as if no discount offer had been purchased. In some cases, the transaction request may also include information indicating or describing the product being purchased, the manicure.

Using the information previously stored at step 202, transaction processor 130 determines that this transaction request is for the manicure associated with the discount offer, for which the customer's account has already been debited (step 206). This may be accomplished by looking up the customer account number and checking for correlation between any purchased discounts associated with the customer account number and the current transaction. Other approaches are also possible. In this case, the customer's account has already been debited $25 for the manicure offer and the customer's account will not be further charged in response to this transaction request.

At step 208, an approval is transmitted to the salon based on the discounted price. This approval is an indication to the salon that their account will be credited for the transaction. The approval may specifically indicate that a $25 transaction has been approved or may more generally indicate that the transaction has been approved without indicating a specific dollar amount. The salon's account will typically not be credited for the full $25 in most cases because credits are typically issued to other entities involved with the publishing or sale of the discount offer and the processing of the transaction.

In some cases the discount of FIG. 2 may not be associated with a particular product. For example, the offered discount may be $50 credit at merchant 120 for a prepayment of $25 by customer 110. In this case, customer 110 may initiate a $70 transaction at merchant 120. When transaction processor 130 receives the transaction authorization request for $70, the pre-purchased discount is identified based on the customer's account number and the $50 discount is subtracted from the $70 transaction resulting in a current charge to the customer's account of only the $20 balance. Neither customer 110 nor merchant 120 is required to take any action to identify the promotion or associate the promotion with the transaction. The information about the promotion and the link to customer 110's account is automatically identified and retrieved from database 132 by transaction processor 130 based o customer 110's account number. In some cases customer 110 and/or merchant 120 may not even be currently aware that the transaction is eligible for an existing promotion.

In some cases the promotion or discount may not involve any pre-purchase by customer 110. In these cases, the promotion or discount information may still be linked with one or more of customer 110's accounts in database 132. When customer 110 conducts a qualifying transaction using one of the accounts, the transaction information is transmitted to transaction processor 130 and any benefits associated with the discount or promotion are automatically applied to the settlement of the transaction.

When processing transactions, various regulations and preferred practices suggest or require that card data and/or account numbers cannot be retained or stored by merchant 120. This information is typically transmitted to transaction processor 130 for purposes of completing a transaction and not retained by merchant 120. As more sophisticated customer rewards programs, marketing programs, targeted marketing programs, and similar programs are conceived and implemented, it becomes more desirable for merchant 120 to be able to monitor and track the activities of individual customers such as customer 110. In some cases, this is done through a separate customer reward/loyalty number that must be separately provided by the customer at the time of the transaction.

In one embodiment of the present invention, a unique identifier or suffix is associated with the account number by transaction processor 130. The unique identifier or suffix is associated with the account and can be used to uniquely identify customer 110 and/or the account. The unique identifier can also be used to track transactions and buying behaviors associated with that account without disclosing the account number. After an initial setup, registration, or opt-in process, the unique identifier or suffix is associated with the account and automatically linked to transactions using that account without customer 110 having to provide the unique identifier, a separate card, a separate rewards number, or any other type of identifier for each transaction.

When customer 110 presents a payment card to merchant 120 for payment, merchant 120 transmits this information to transaction processor 130 for authorization of the transaction. In addition to authorization for the transaction, transaction provider 130 provides the unique identifier or suffix to merchant 120 in order to allow merchant 120 to uniquely associate customer 110 with the transaction without retaining the payment card or account number and without customer 110 having to provide any additional card or information to merchant 120. Over time, merchant 120 is able to aggregate information about the customer purchasing behaviors for marketing analysis, targeted marketing, or for other purposes. Transaction processor 130 or another entity may also perform this data aggregation function. Merchant 120 is able to maintain this information to implement a customer rewards or loyalty program without generating or providing a card that the customer must provide for each transaction. Customer 110 may be required to opt-in or otherwise indicate agreement to participate in a program of this nature.

In addition, the unique identifier or suffix may be used for distribution or tracking of transaction related information to parties other than merchant 120. For example, a customer may opt-in for a program in which his/her transaction information is shared across multiple merchants or other types of companies. Using the suffix as an identifier of customer 110 or customer 110's account, merchant 120 may also receive information about customer 110's buying behaviors or transactions at other merchants. Merchant 120 may be a provider of outdoor clothing that customer 110 has patronized in the past using a payment card and the associated unique identifier. If customer 110 purchases snow skis at a different merchant, transaction processor 130 may provide this information about the other purchase to merchant 120, as well as to other merchants. The information may only be provided to a select group of merchants, a coalition of merchants, or a group of merchants approved by customer 110. The provided information describes the purchasing behavior of customer 110 at the other merchant and identifies customer 110 using the unique identifier. Based on information about the customer's purchase of snow skis received from transaction processor 130, merchant 120 may choose to direct a targeted offer to customer 110 advertising their ski clothing or offering a personalized discount offer of another type.

In some cases, the identifier includes two or more parts. One portion of the identifier is a common portion that uniquely identifies the customer and/or the account as described above. A second portion of the identifier may identify specific merchants, advertisers, promoters, or publishers. In this way, information transferred using the identifier can still be uniquely associated with the customer, as described above, while also identifying another party associated with the information. The other party may be a merchant the transaction was conducted at, a party the information is being transferred to, or a party the information is being transferred from.

The transaction information described above may be distributed to other parties using the unique identifier in a similar manner. For example, promotion processor 150, promotion distributor 140, and advertising entities of other types are interested in gathering information about customers describing their purchasing behaviors or transaction histories. These parties may be interested in utilizing this information on an individual basis or aggregating this information across groups of customers including groups of customers having specific characteristics. In addition to using this information to formulate future promotional activities, various entities may also use this information to track whether a particular promotion has been redeemed, without utilizing the customer's card or account number. Promotion processor 150 and/or promotion distributor 140 may also receive information about specific customers in order to target specific offers or promotions at those customers. The link between these various types of information and the account of customer 110 can be retained by transaction processor 130 and/or within database 132. The unique identifier or suffix is used to allow this information to be automatically linked as well as distributed to various parties without divulging customer 110's account number and without requiring customer 110 to provide an additional number or card at the time of the transaction.

An identifier of the type described above may also be used to link multiple accounts of customer 110. The single identifier enables the transactions and buying behaviors across multiple accounts to be identified, tracked, or aggregated to accomplish objectives similar to those discussed above, but across multiple accounts of customer 110. These multiple accounts may include different types of accounts (e.g., debit, credit, and prepaid accounts). These multiple accounts may also include different accounts of the same type (e.g., Visa, MasterCard, and Discover credit accounts or multiple Visa accounts). The information from multiple accounts linked using the single identifier may be consolidated to provide a picture of the overall purchasing behavior for a particular customer, or for a family of customers. In addition, the information may be aggregated across customers to provide information to merchants and promotion publishers regarding which types of accounts are most likely to be used for their products, the overall buying habits of their customers, and for other types of analysis pertaining to account usage and buying habits.

The multi-account identifier described above may be used to share the combined information associated with multiple accounts to merchants, offer providers, offer publishers, card issuers, advertisers, or other marketing entities. As discussed previously, agreement or approval from customer 110 may be required before this information may be shared among the various parties. In addition, customer 110 may use this single identifier for managing the multiple accounts. For example, customer 110 may use this identifier to quickly determine a combined current balance across the multiple accounts, a combined amount of credit available across the accounts, or other pertinent information that spans the accounts. A card issuer, or other entity, may provide statements or other reporting to customer 110 that include information associated with all of the accounts that are linked by or associated with the multi-account identifier. The single identifier could be a randomly generated number or could be a phone number, an email address, a social media identifier, a government identification number, a randomly selected identifier, or a biometric identifier. The identifier, alone, cannot be used to make charges to the account(s), but is used to manage and distribute information associated with the account(s).

After one or more customer accounts or payment devices have been registered, many different types of reporting and analytics associated with customer spending behavior are possible. These analytics may pertain to a single payment type, a group of payment types for a single customer, a single payment type across multiple customers, or other combinations of customers and payment types. In one example, analytics are generated to predicting which types of customer prefer which payment types. In a further example, the analytics may indicate which payment type customers prefer for particular types of transactions (e.g., do a higher percentage of men than women use debit cards at grocery stores? Do customers use American Express at electronics stores more frequently than they do at other types of stores?). Many other types of analysis and reporting are possible and the invention is not to be limited to the specific analysis examples provided here.

When transactions involve promotions, many additional analytic processes may be performed with respect to the redemption of those promotions. Some examples of possible redemption analytics are:
How long it took the customer to redeem the offer
How much the customer spent in the transaction associated with the redemption
How the amount of the redemption transaction compares to a typical transaction at the merchant or to a typical redemption transaction at the merchant
How the consumer's behavior compares to other consumers' behaviors
Whether the customer performed a transaction at a merchant subsequent to purchase of a promotion associated with the merchant without redeeming the promotion
How long it took the customer to make another purchase after the redemption transaction
The amount of a transaction made after the redemption transaction
Comparison of the customer's post-redemption behavior to behavior of other customers or groups of customers or post-redemption behavior of other customers or groups of customers
Determinations regarding the types of incentives that drive the most desirable customer behavior
Determinations of the lowest cost promotions that drive the desired behavior most effectively or have the best financial rate of return
Identification of preferred customers, preferred customer types, or preferred customer groups
Identification of common behaviors shared by the best customers
Identification of marketing strategies or opportunities for improving customer behaviors and business results

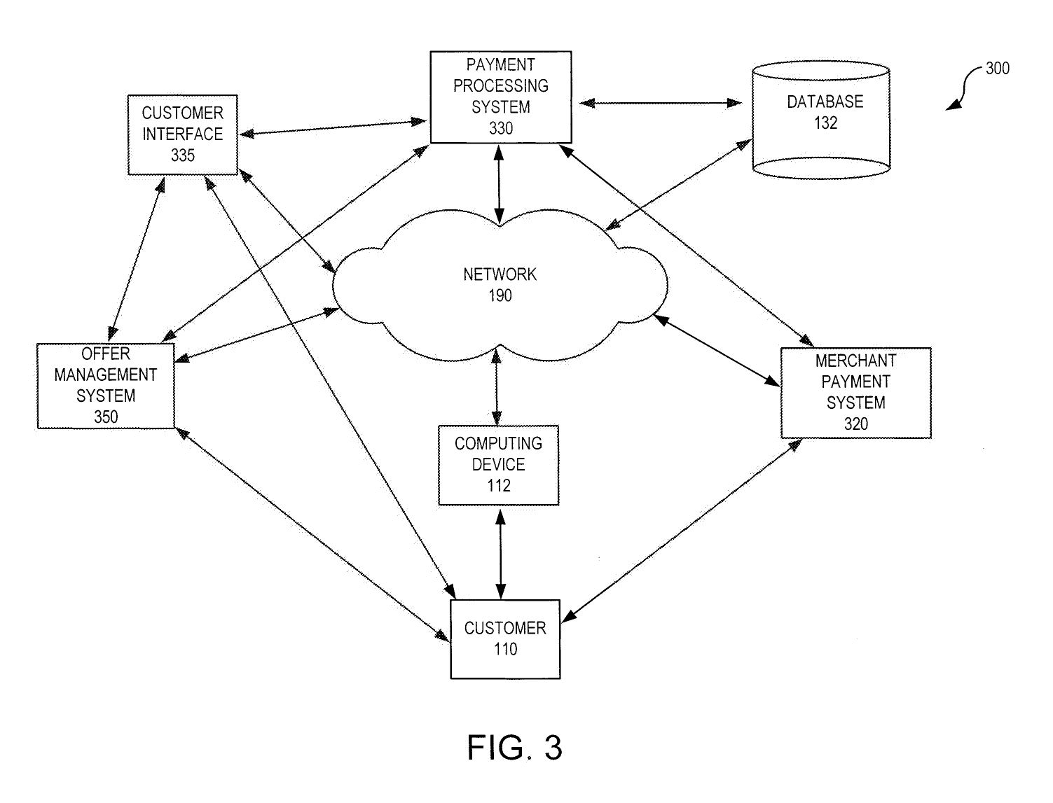

FIG. 3 illustrates operating environment 300 in which some embodiments of the invention may be implemented. Operating environment 300 includes customer 110, computing device 112, network 190, database 132, merchant payment system 320, offer management system 350, payment processing system 330, and customer interface 335.

Payment processing system 330 comprises one or more computing devices for receiving and processing transaction or payment requests. In some cases, payment processing system 330 is used to process and settle credit and debit card transactions. Payment processing system may be a computer or a server and includes software and a communication interface for conducting payment processing functions. Payment processing system 330 is typically operated by a payment or transaction processor, such as transaction processor 130. Payment processing system 330 may also interface to banking systems or other financial systems in order to conduct account settlements.

Merchant payment system 320 comprises any electronic system used by a merchant to receive customer payment information and communicate payment request authorizations to payment processing system 330. Merchant payment system 320 may be a computer, a server, or a dedicated function computing device. In one example, merchant payment system 320 is a web server configured to perform customer transactions through a network connection. In another example, merchant payment system 320 is a point of sale (POS) terminal. The functions of merchant payment system 320 may also be distributed across multiple devices.

Offer management system 350 comprises any electronic system used by one or more of an offer provider, an offer publisher, an offer promoter, or an offer processor. Offer management system 350 may be a computer, a server, or a dedicated function computing device and may include software for managing and processing offers or promotions. The functions of offer management system 350 may be distributed across multiple devices.

Customer interface 335 is any type of interface used by customer 110 for establishing a profile or managing one or more accounts within payment processing system 330. Customer interface 335 may be a web page implemented on a web server. Customer interface 335 may be accessed by customer 110 using computing device 112 or another electronic device. Customer interface 335 may be implemented using software running on a computing device that makes up payment processing system 330. Customer interface 335 may also be implemented in a dedicated electronic kiosk, in an automatic teller machine (ATM), in merchant payment system 320, or in an interactive voice response (IVR) system.

Customer 110 uses customer interface 335 to establish a profile and manage various parameters or settings associated with his or her accounts. Establishing a profile may include establishing one or more account identifiers, linking multiple accounts to a single identifier, linking the profile to an identifier associated with a social media environment, providing an email address, providing or updating contact information. The profile may also enable the customer 110 to indicate whether transaction information associated with the accounts will be made available to various merchants, offer publishers, offer promoters, or other entities. Customer 110 may make these indications within the profile on a one-by-one basis or categorically. Customer 110 may also select or opt-in for specific promotions, offers, or programs using customer interface 335. The profile information may be stored in database 132 or in another data storage system. Customer 110 may also use customer interface to view account agreements, user agreements, disclaimers, or legal agreements associated with the functions described herein.

Customer 110 may also use customer interface 335 to view and manage promotions customer 110 has already selected, to view redeemed promotions, to receive promotion opportunities, or to shop for additional promotions. For example, customer 110 may participate in three different ‘daily deal’ type programs. Information associated with promotions customer 110 has selected or purchased from all three of these providers may be loaded in database 132 and available in payment processing system 330 and viewable through customer interface 335. Each of the three offer providers may operate a system such as offer management system 350. The promotion information may be loaded by or retrieved from the one or more instances of offer management system 350. Using customer interface 335, customer 110 can update a profile, payment, or other information for all three providers using this single interface. Customer 110 can also view and manage existing discounts or coupons available in the customer's account using customer interface 335.

Publishers, promoters, and/or offer providers may also contact customer 110 or make offers through customer interface 335. Customer 335 may also use this interface to manage settings for a group of payment cards or accounts, such as for an entire family or for a group of employees. Payment processing system 330 may also provide an interactive interface for offer promoters, offer publishers, and/or merchants for gaining centralized access to customer information, transaction information, and the various analytics described herein.

In another embodiment of the invention, payment processing system 330 may include links to other types of payment processes or systems. For example, person-to-person (P2P) payments are becoming more common. Examples of P2P payments include direct bank transfers between customer accounts, PAYPAL®, mobile payments, mobile wallets, transfers within social environments, alternate currencies, and other systems. The transaction processing system described herein links to these other various P2P payment systems and links to transactions in these other systems. These links may be used to gather additional information about consumer behavior and gives advertisers and promoters access to additional information on which to make marketing decisions, as well as access to additional transaction to which promotions may be attached. Because these other types of transactions often do not typically include a credit or debit card account number, other types of identifiers may be used to link the P2P and other accounts together with the accounts of customer 110 that are traditionally processed using payment processing system 330. Customer 110 may be offered a reward or promotion for linking his or her accounts in these other environments in this manner. Payment processing system 330 may link to these other systems through network 190 or through a dedicated interface. In this way, payment processing system 330 may be a centralized source for gathering information about all of these types of transactions or linking offers to all of these types of accounts or transactions.

Payment processing system 330 may also be configured to perform transactions between traditional and non-traditional payment systems. For example, customer 110 may participate in games in a virtual environment. Payment processing system 300 may be configured to provide credits or other benefits to customer 110 in the virtual environment in response to a transaction in the traditional payment system. For example, a promotion may be provided in which customer 110 is given additional “lives” in a virtual game for each $100 spent at merchant 120. Payment processing system 330 is able to automatically manage these actions across the two environments using an electronic interface to one or more systems operating the virtual environment. An offer could also be associated with purchase of a specific product or meeting the requirements of a series of transactions, including a series of transactions across multiple merchants.

In some cases, customer 110 may be required to perform certain actions or transactions in both the virtual and traditional environments in order to satisfy the requirements of a promotion. For example, customer 110 may be required to reach a certain level in a virtual game and purchase a designated product or spend a designated amount at merchant 120. Payment processing system 330 gathers information related to the various qualifying elements and link them based on the customer's account number(s) and/or identifier(s) without the customer, merchant, or game provider being required to coordinate any documentation or records of these transactions.

A reward provided to customer 110 in the virtual environment could be many things including special game pieces, virtual currency, points, virtual resources, or other items of benefit in the virtual game or in the virtual environment. Centralized linking of customer 110's traditional accounts, non-traditional accounts, as well as offers and promotions allows the customer's fulfillment of the requirements of an offer to be automatically tracked and credited. In some cases, the operator of payment processing system 330 charges a fee to the other various entities involved in these types of transactions.

Using the described links between virtual accounts and traditional accounts, payment processing system 330 may also provide customer 110 credit in a traditional payment environment for activities conducted in the virtual environment. For example, if customer 110 spends a required amount of time participating in a virtual game, payment processing system 330 may automatically attach an offer or a credit to customer 110's credit card account. If a customer has already linked the virtual account to the credit card account, this offer or credit can be attached automatically without any specific action required on the part of customer 110 or the virtual game provider. In addition, if customer 110 has multiple card accounts linked together, customer 110 may redeem the offer using one of the other card accounts, without providing any additional information, because payment processing system 330 will have attached the offer to all of the linked accounts. In some cases, the virtual game may be provided by merchant 120 and the offer may be for a product or service offered by merchant 120.

In addition to getting credit for participating in virtual games, a credit or offer may be applied or attached customer 110's non-virtual account based on other behaviors in the virtual environment. For example, a product manufacturer or merchant may track customer 110's own promotion of the product, manufacturer, or merchant in the virtual environment and reward the customer 110 accordingly. Promotion by customer 110 may include mentioning, posting a picture, positively reviewing, or otherwise bringing the product, manufacturer, or merchant to the attention of others in the virtual environment. The magnitude of the reward may depend on a number of views of the information, the number of followers customer 110 has in the virtual environment, the number of comments generated by a picture or posting, or another measure of the exposure of the information provided by customer 110.

In one example, a manufacturer may automatically apply a $5 credit to customer 110's account to be used toward purchases of that manufacturer's product for every twenty five views of a picture of the product posted by customer 110 on FACEBOOK® or another social media site. The benefits provided to customer 110 in the traditional transaction environment may also be based on other aspects of activities in the virtual environment. For example, the awarding of credits or offers to customer 110's account may be based on competition among multiple customers in the virtual environment, including proportional rewards based on the relative performance of the customers. Payment processing system 330 is configured to automatically monitor and track any of these activities in various environments and apply credits or rewards accordingly.

In another example, a restaurant may provide credit to customer 110's account to be used at the restaurant in response to customer 110 blogging a review of the restaurant. The amount may be based on the number of regular readers of the blog, the number of readers of the specific post about the restaurant, the number of comments on the post, or some other metric. By linking multiple accounts with a single identifier as discussed previously, customer 110 will automatically get the credit at the next visit to the restaurant regardless of which of the registered cards is used. The activity can be monitored by payment processing system 330 such that the restaurant is not required to perform any steps for the credit to be properly applied to a transaction. The credit is automatically identified during transaction processing such that customer 110 also does not have to provide any information other than the payment card.

In another example, customer 110 may be given credit or opportunity to exercise an offer or promotion based on “checking-in” at merchant 120's location or agreeing to an automatic post in the virtual environment such as “Customer 110 just received a great deal on a digital camera at Merchant 120.” The posting may be automatically generated or triggered by payment processing system 330 based on the processing of the transaction and customer 110's virtual environment identifier that is included in customer 110's profile. As described above, customer 110 may receive additional credit or rewards depending on how many times the posted information is viewed or how many followers customer 110 has.

In another embodiment of the invention, payment processing system 330 provides various types of notifications based on the types of transactions conducted by customer 110. For example, real-time or near-real-time notifications may be transmitted if a transaction is conducted at a specified merchant, at a specified type of merchant, for a certain type of product, if the transaction occurs inside or outside a specified window of time, or if the transaction exceeds a specified dollar amount. Using customer interface 335, customer 110 may specify and/or change various parameters related to these types of notifications. Customer 110 may also set the parameters differently for different accounts or account numbers. Notifications may be sent to customer 110, an employer, a parent, or another party. In a variation of this embodiment, notifications may be requested by and/or sent to other entities including government entities or law enforcement agencies. Depending on the party requesting the notification and the type of notification requested, customer 110 may or may not need to agree to the notifications to satisfy various legal and/or privacy requirements.

There are multiple ways that payment system 330 could use transaction information send real time notification feeds. Payment system 330 could take a copy of the information at the front end and send to relevant parties to perform actions. Payment system 330 could also send the transaction out for authorization to the various authorization platforms and once the payment system received approval on the authorization, it could send the notification to the parties of interest.

The notification features described above may also be used in other contexts. The notifications may be used to notify a group of customers or users regarding progress towards a goal. For example, a local grocery store may agree to provide uniforms for a local youth soccer team if customers associated with the team make a specified amount of purchases at the store within a designated period of time. Notifications may be sent to the entire group of participating customers by payment processing system 330 in order to notify them that a threshold has been met or to notify them of the status of the program. In another example, members of a hobby group may receive increasing levels of discount at an online hobby store based on levels of purchases made at the store by members of the group. The accounts used to make the purchases are registered as members of the group and notifications are sent to all members of the group communicating status of the promotion and discounts. The alternate unique identifiers or card suffixes discussed in previous embodiments may be used in order to uniquely identify the customers and their accounts without revealing the customers' card or account numbers. In another example, a ‘daily deal’ promotion may be offered for sale but may not become active or valid until a specified number of customers have purchased the deal. Payment processing system 330 may use the notification features described herein to notify groups of customers about the status of these types of promotions.

Payment processing system 330 may also transmit a notification to customer 110 in response to a transaction for informational purposes. For example, a notification may be sent to an email address associated with the account to thank customer 110 for having conducted business at merchant 120 or to provide additional information regarding how to get service for a purchased product.

Just as the features of payment processing system 330 described above may be used to provide benefits to groups of customers, the features of the system may also be utilized to benefit groups of merchants and publishers. For example, merchants and/or promotion publishers may create groups or coalitions among which any of the various types of transaction data described herein is shared. If customer 110 agrees to share certain types of transaction information, or other profile information, with merchant 120, merchant 120 may agree to make this information available to members of a group or coalition including other merchants in exchange for cross-marketing benefits, participating in joint promotions, or other business benefits. For example, a promotion may be created in which the customer receives a benefit or reward for meeting transaction requirements at multiple merchants of the group or coalition. The previously described transaction notifications may be used to notify other merchants in the group or coalition when the customer has completed one or more of the purchase requirements. This information may be used by another merchant to prompt the customer to complete additional transactions toward the group reward or by an offer promoter to identify customer 110 as a good target for an additional offer.

In another example, merchants within a particular geographical proximity of each other may choose to cross-market based on each other's transactions with customer 110. When customer 110 makes a purchase at merchant 120, payment processing system 330 identifies a second merchant and automatically generates a promotional offer for the second merchant. This offer is transmitted to customer 110 in an attempt to leverage the fact that customer 110 is shopping in the area. The second merchant may be identified based on various factors including: membership in a group or coalition with merchant 120, membership in customer 110's group of preferred merchants, a record of previous transactions with customer 110, or based on other business relationships, including combinations thereof. Merchants in a group or coalition may also be able to leverage information about transactions already conducted by customer 110 to make any additional offers or promotions targeted at products or services related to customer 110's previous purchases. Customer 110 may use customer interface 335 to subscribe to an entire group or coalition of merchants. Merchants may be able to actively query payment processing system 330 and/or database 132 to retrieve this type of prior transaction information or it may be pushed out to the merchants' systems.

In some implementations, offers to customers may be valid across an entire group or coalition of merchants. For example, all customers who have previously opted-in may be offered a 15% discount on all purchases at the designated merchants for a specified period of time. Notifications advertising the promotion are automatically sent to the customers using the contact information in the customers' profiles. In some cases, customer 110 may be able to take advantage of the offer without individually opting in for the specific offer and without taking any other action. The offer may be automatically attached to customer 110's account such that any qualifying transactions are automatically adjusted without customer 110 having to present a coupon or redemption code, as long as the registered form of payment is used, and without any additional action on the part of the merchant. Because the system is capable of tracking activity across all of the merchants in the group, customer 110 may also receive an increasing level of reward based on level or frequency of participation in the offer. Detailed tracking regarding which customers have acted on the promotion, at what merchants, and/or the details of those transactions may be used by the merchants in the group to distribute the costs or benefits of the promotions among the group.

The various types of offers and promotions described herein may also be dynamically applied to a transaction by payment processing system 330 at the time the transaction is being processed. In one example, a submitted transaction may be eligible for multiple promotions or transactions. The range of eligible promotions may be based on promotions that have been specifically associated with customer 110's account(s) or may be promotions which are more broadly available for a particular type of customer, group of customers, category of product, or merchant. Each offer or promotion includes metadata stored in database 132 that describes the rules or requirements for redemption. Payment processing system 330 includes a redemption engine that processes the transaction and analyzes a plurality of available promotions to determine the best or most desirable promotion(s) to apply to the transaction. The best or most desirable promotion may be determined based on many factors including:
Maximizing Discount Amount—may be based on an absolute discount amount, a percentage, or both
Required Product—whether a product necessary to satisfy the requirements of the promotion is included in the transaction
Discounted Product—potential application of a discount to different products in the transaction
Minimum Transaction Amount—whether a minimum total transaction amount is satisfied
Minimum purchase product quantity—whether a sufficient number of the promoted products have been purchase to satisfy requirements of the offer
Maximum discounted product amount—whether there is a maximum limit on the available discount for a product (i.e., 20% off a single product up to a maximum discount of $15)
Maximum discounted product quantity—whether there is a cap on the number of products to which the offer applies (i.e., $10 pepperoni pizzas, limit 2)
Maximum discounted amount—whether there is a maximum amount on the available discount for the entire transaction (i.e., 10% off all items in the purchase, up to a maximum discount of $50).
Maximum redeemable count: whether there is a limit on the number of different times a customer can redeem the offer (i.e., $10 discount on each visit for three visits)
Presentation Device—indicates how the offer should be presented to the customer
Offer expiration date—latest date on which the offer can still be redeemed

An offer may apply to a particular product or service or it may require that one or more particular products or services be purchased. In order to validate that the requirements of these types of offers are satisfied, information describing the products or services associated with the transaction may also be transmitted to payment processing system 330 by merchant payment system 320 in some embodiments. In one example, this may be accomplished by transmitting the stock-keeping units (SKUs) of the products involved in the transaction in conjunction with the transaction authorization request. A SKU is a number or code used to identify each unique product or service for sale at a merchant. The received SKUs are compared against SKUs identified in information describing the offer by payment processing system 330 to determine if the requirements of the offer have been met.

Using customer interface 335, customer 110 may also be able to provide preferences, parameters, or rules that affect the best offer selection process described above. In one example of a customer preference, customer 110 may indicate a preference for immediate savings even if the immediate savings are less than potential future savings. While processing a transaction, payment processing system 330 may determine that two offers are available for the transaction. The first offer is for 10% off of the current purchase. The second offer is for $30 off of a future purchase. If the customer is making a $230 purchase, logic which is based on the best offer only may result in selection of the $30 offer because it provides the largest overall benefit. However, because customer 110 has indicated a preference for maximizing immediate savings, the 10% offer (providing a $23 saving on the current transaction) will be selected because it provides a current savings rather than a future savings opportunity. It should be understood that many other types of customer rules and preferences that affect the offer selection process are possible.

Payment processing system 330 also includes enhanced transaction features for applying offer bidding to transactions. In addition to the offers and offer information available in database 132, payment processing system 330 may also accept or solicit bids from various offer publishers or providers for a pending transaction submitted by merchant 120. This is accomplished by transmitting a request for offers to various providers or retrieving available offers from external offer systems, such as offer management system 350. External publishers or systems may provide their best offer for the pending transaction on a real-time or a near real-time basis. The publishers or systems eligible to provide offers or bids may be limited to publishers that have already been accepted by customer 110 and/or publishers who have an agreement with or are in a coalition with merchant 120.

In some cases, payment processing system 330 will select the best offer from among the bids using decision logic of the type described in previous examples without the customer having visibility to the offers considered. In other cases, some or all of the valid bids may be transmitted to customer 110 for selection by customer 110. This information could be made available to customer 110 through computing device 112, merchant payment system 320, or customer interface 335. Regardless of how the offer is selected, payment processing system 330 processes the transaction using the selected offer. In some cases, none of the offers may be selected and payment processing system 330 may proceed without any offer being applied to the transaction. Publishers and offer providers may wish to provide offer bids on a transaction-by-transaction basis rather than loading fixed offers into database 132 for various reasons including: a desire to frequently change or update offers based on market conditions, a desire to vary offers depending on the specific product associated with the transaction, a desire to adjust offers based on the identity of the customer, or for a combination of these reasons.

Because customer 110 may have already made a decision to proceed with a transaction at the time the request is received by payment processing system 330, any offers provided in the offer bidding process described above may be for ancillary products or services. If customer 110 has already made a decision to buy a new computer and the payment for the computer is being processed, there may be little incentive or reason to offer a discount or promotion that applies directly to the computer. However, the offer bidding process may be used to identify competitive offers for a warranty or service plan for the computer. In another example, the offer could involve a promotional discount on accessories for the computer at the selling merchant or at another merchant. In some cases, the amount of the transaction may be increased to accommodate the price of an offer accepted by the customer.

In the computer example, the transaction submitted for purchase of the computer is a $600 authorization request. Multiple providers bid to attach a discount offer to the transaction for a computer case. An offer is accepted giving customer 110 a $75 credit at a partner merchant that sells computer accessories. The cost of the offer is $40. The transaction amount is adjusted to $640 and the information about the accessory offer is attached to customer 110's account in database 132. When customer 110 shops at the accessory merchant and initiates a qualifying transaction, using the same payment account or an associated payment account, the $75 credit is automatically applied to the transaction without customer 110 or the accessory merchant having to provide a discount code, a coupon, or otherwise initiate application of the credit. In other words, the transaction associated with customer 110's purchase of a $90 computer case is adjusted by payment processing system to have a $15 transaction amount. As discussed in other examples, the transaction at the accessory merchant may also proceed for the full $90 amount with the $75 adjustment being made in post-processing.

Payment processing system 330 may also facilitate the offer bidding process prior to receiving a payment authorization request. In other words, customer 110 may have the ability to request the available offers prior to committing to purchase the product or service. In one example, customer 110 is very interested in an advertised product and clicks a link that says ‘get offers.’ A request for offers is transmitted to payment processing system 330 prior to a request to authorize payment. Payment processing system receives the available offers from database 132 and/or from offer management system 350 through the offer bidding process described above and presents the available offers to customer 110. The offers may be presented to customer 110 through computing device 112, customer interface 335, or merchant payment system 320. After one or more of the offers is selected for the transaction, customer 110 may decide to proceed with the transaction and an authorization for payment is transmitted to payment processing system 330 to cover any remaining amount associated with the transaction.

In addition to offers being provided directly by publishers or providers, payment processing system 330 also allows customer 110 to load offers or coupons into payment processing system 330 and attach these offers or coupons to his or her account. These customer-loaded offers may be encountered by customer 110 in a number of different ways and may exist in different forms. In addition, these offers may be loaded by customer 110 using several different techniques, as described below.

Customer 110 may encounter offers while browsing web pages, reading email, listening to the radio, watching television, or reading a magazine or newspaper. If customer 110 encounters an offer in any of these mediums, customer 110 may attach the offer to his or her account by logging into his or her profile in payment processing system 330 through customer interface 335 and entering pertinent information that identifies the offer. The information that identifies the offer includes one or more of: a code associated with the offer, a description of the offer, the merchant, the offer provider, or the product. Once customer 110 has attached this offer to his or her account, it will automatically be applied to any qualifying transaction using the systems and methods described herein. For example, customer 110 sees an advertisement on television for 30% off of auto detailing services at merchant 120 and a discount code is provided. Customer 110 logs into his or her account using customer interface 335, enters the code, and that discount is attached to one or more payment accounts of customer 110. Presuming it has not expired, the discount will automatically be retrieved when customer 110 pays for the qualifying auto detailing services at merchant 120 at a later time using any registered card. The discount will be automatically applied to the transaction by payment processing system 330.

A similar offer loading process is provided for offers encountered in interactive electronic environments such as on web pages or in email messages. Customer 110 captures a code or some other piece of information that appears on a web page or in an email message and loads that information into the profile using customer interface 335. This process may also be automated using hyperlinks. Clicking on a hyperlink in an email address or an advertisement on a web page that is associated with a hyperlink takes customer 110 directly to a web page associated with customer interface 335. Customer 110 may still be required to enter a username and/or password to access the profile, but sufficient information may be included in the hyperlink to automatically load the offer into customer 110's account without customer 110 be required to remember any codes or perform any copying or pasting of codes or other offer information. In this way, customer 110 can browse the Internet and easily load offers of interest into the profile with minimal additional effort.

If customer 110 does not have an account or profile established, following one of the promotion links described above may lead customer 110 to a web page encouraging registration for an account or advertising the enhanced transaction processing features described herein. Customer interface 335 may also provide listings of offers enabling customer 110 to shop for offers and/or search for offers for which customer 110 has a vague recollection but does not remember the specific details.

Customer 110 may also wish to load non-electronic coupons or offers that are encountered in non-electronic environments. Customer 110 may encounter advertisements or offers on printed materials such as magazines, posters, newspapers, billboards, or other types of printed advertisements. Customer 110 may manually load these types of offers by entering a code or other information as described above. Alternately, customer 110 may electronically capture the offer information from the printed material using a smartphone, or other electronic device, with a camera or scanner. In one example, customer 110 takes a picture of a bar code or a quick response (QR) code printed on the materials and uses application software in the smartphone to have the offer automatically loaded to their profile in payment processing system 330 in a manner similar to that described above with respect to loading offers by clicking on hyperlinks. In some cases, customer 110 may encounter the advertisement in a situation where they are not able to take a picture or record a significant amount of information. In these situations, the advertisement may simply provide a text messaging code that customer 110 can text to receive more details about the offer. The response to customer 110's text can include more information about the offer, information about how to load the offer to the profile or account, and/or a hyperlink to simplify the offer attachment process as described in previous embodiments.

Customer 110 may also load offers using by calling an IVR system. When customer 110 wants to load an offer, a call is placed into the IVR system and customer 110 provides the necessary identification information as well as information needed to identify the offer. The information may be communicated through audible statements and/or through menu choices made using a phone keypad. The IVR system may be included in payment processing system 330 or may be external to payment processing system 300. Based on the input of customer 110, the IVR system assists the customer in identifying the offer using database 132, or by querying other sources such as offer management system 350, and attaches identified offers to customer 110's profile or account.

In another variation of customer-loaded offers, customer 110 loads traditional paper coupons so the associated discounts are available for future transactions and can be automatically applied by payment processing system 330. Once loaded, customer 110 does not have to provide the paper coupons at the time of the transaction. Rather than clip and take the paper coupon to a store for redemption, customer 110 uses information printed on the paper coupon to load the coupon into the profile. Customer 110 can enter the information in a manner similar to that described above for other types of printed advertisements and offers. This may include manually entering information from the printed coupon through customer interface 335, calling the IVR, transmitting a scanned image of the coupon to payment processing system 330, or taking a photo of the printed coupon and transmitting it to payment processing system 330. As in the other examples, once the coupon is loaded into customer 110's profile, it will automatically be identified and applied by payment processing system 330 to eligible transactions made using a registered card or account. As with other promotions, the database of loaded and redeemed coupons provides merchants with proper access to that data an extensive database or marketing information for individual customers as well as for groups of customers.

Regardless of how an offer is entered, payment processing system 330 contains logic for performing other actions related to the offer and/or links to other systems for performing these other actions. These other actions include: verifying validity of the offer, requesting detailed eligibility requirements for the offer, and determining an expiration date for the offer. These features may be used to actively manage each customer's collection of offers. Managing the offers includes, for example, linking related offers or offers that have a dependency relationship, eliminating duplicate offers, eliminating expired offers, and sending reminders to customer 110 for offers that are nearing expiration.

Once customer 110 has offers loaded into the profile, payment processing system 330 provides tools allowing customer 110 to perform actions with respect to the offers in addition to the redeeming of those offers. Customer 110 may transfer an offer to another customer. Customer 110 may trade one or more offers to another customer in exchange for one or more other offers. Customer 110 may also sell offers to another party or exchange an offer for credits or other types of rewards in a virtual environment. In some cases, payment processing system 330 may also facilitate return or buybacks of pre-purchased promotions in cases in which the merchant or an offer provider may be interested in providing the customer holding the offer some compensation in exchange for relinquishing the offer.

In each of the embodiments discussed above in which a discount or promotion is applied to a transaction, the adjustment to the transaction may occur in a number of different ways and at different stages of the transaction cycle. In one example, any discount or adjustment to the transaction is applied at the same time as the authorizing of the transaction. For example, merchant 120 transmits a request for authorization of a $300 purchase on customer 110's credit card account. Payment processing system 330 identifies an offer attached to customer 110's account providing a 15% discount at merchant 120. Presuming the offer is valid and other requirements are met, payment processing system 330 reduces the transaction amount by $45 and an authorization is sent back to the merchant for a $255 transaction. Payment processing system 330 then settles the transaction using known methods based on the $255 transaction amount.

In an alternate situation, adjustments to the transaction amount are made on a non real-time basis after the initial processing of the transaction for the full amount. Using the same example, the transaction is initially processed for the full $300 and an authorization for the $300 is sent to merchant 120 to complete the transaction with customer 110. Later, transactions are analyzed in post-processing to identify and apply any applicable offers or discounts. In some cases, the customer 110's account may initially be debited for the full transaction amount and the merchant 120's account credited for the full transaction amount. The amount credited to the merchant may also be reduced based on any applicable transaction fees. Later, when the offer is identified and verified, an adjustment is made in the form of a credit to the customer account and a debit to the merchant account in the appropriate amount based on the offer. In some cases, additional steps may be taken to protect against application of duplicate credits or premature application of credits. For example, a delay period may intentionally be provided between the transaction and the application of credits to insure that the transaction is not canceled or reversed after a short period of time. Payment processing system 330 may also include checks to determine when a return or transaction cancellation takes place in order to make sure any debits or credits that have been applied in conjunction with an offer are properly reversed if the product is returned or the transaction is otherwise canceled.

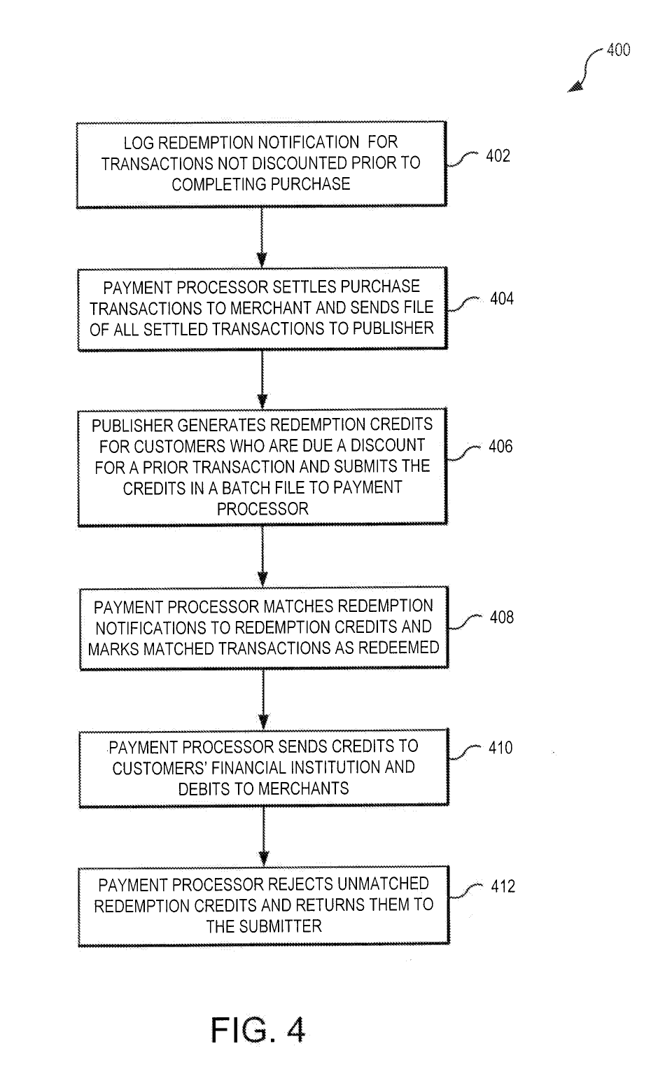

In other cases, delayed settlement of the offer may include allowing the determination regarding whether a customer or transaction is eligible for an offer, and the associated discount, to be made by another system or party. FIG. 4 illustrates method 400 in which settlement of promotion discounts occurs in post-processing after the associated transaction has already been completed. Using the illustrated method, an offer processor maintains responsibility for determining if offer redemptions are valid and maintains control over whether customers receive credit for redemptions.

In method 400, redemption notifications are logged for all transactions involving discounts where the discount was not applied to the transaction prior to completion of the purchase (step 402). In some cases, all transactions may be handled in this manner. In other cases, discounts may be applied to some transactions in real time while the discounts for other transactions are handled in post-processing as illustrated in method 400. A determination as to which transactions are handled in this manner may be based on many factors including: the identity of the customer, the identity of the merchant, the identity of the promotion publisher or provider, the size of the transaction, the size of the discount, the percentage of the discount relative to the transaction, the balance of the customer account, the transaction history of the customer, or a preference of any of the involved parties.

At step 404, the payment processor settles the purchase transactions to the merchant for the original transaction amounts and sends a file or other set of information indicating the settle transactions to the offer publisher. At step 406, the offer publisher generates redemption credits for customers who are due a discount for one of these transactions and submits the associated credits to the payment processor. In this way, the payment processor facilitates the process, but allows the offer publisher to maintain responsibility for making the determination as to which customers/transactions are eligible to have discounts applied. At step 408, the payment processor matches redemption notifications to the redemption credits and documents that the offers associated with these transactions have been redeemed. For the eligible transactions, the payment processor, at step 410, sends credits to the customers' financial institutions in appropriate amounts to offset the debit associated with the initial processing of the transaction in the discount amount and sends debits to the merchants or the merchants' accounts. At step 412, the payment processor rejects any unmatched redemption credits and returns them to the merchant, customer, or other submitting entity.

The methods described herein may also be used for personalized marketing of promotions and/or increasing traffic at one or more merchants. A targeted offer may be created base on the various types of customer purchase behavior data, promotion redemption data described, and offer participation metrics described herein. In some embodiments, creating a targeted offer for customers includes analyzing purchase data of many potential customers to select customers from one or more of several groups. The groups include customers who have purchased a product or service similar to the product or service of the merchant from another merchant, customers who have patronized another merchant offering a product or service similar to the product or service of the merchant, customers who have purchased a complimentary product or service, customers who have infrequently patronized the merchant, and customers who have patronized the merchant in transactions involving low purchase amounts. In some embodiments, the analysis of purchase data may span customer purchase activity at a variety of merchants. The analysis of purchase data may also occur on a periodic or ongoing basis in order to monitor customer buying behavior on a real-time, or near real-time basis.

Once a purchase and redemption are complete, payment processing system 330 may also be capable of tracking other purchase behaviors of customer 110 to determine how effective the discount offer was for merchant 120, even with respect to customer 110 specifically. For example, payment processing system 330 may be configured to determine if customer 110 made additional purchases from the merchant after redemption of the offer, how frequently, what types of products were purchased, in what quantities, whether customer 110 began patronizing another merchant with similar products, or myriad other metrics. As a central clearinghouse payment and promotion redemption transactions, payment processing system 330 is in a unique position to have access to and make use of transaction information for these purposes.

Payment processing system 330 is also capable of tracking customer spending across multiple marketing partners and multiple merchants such that data can be aggregated on behalf of multiple publishers, merchants, and other parties in order to further refine targeting of offers and incentives. Because payment processing system is capable of interfacing with multiple promotion sources and providers, it provides the ability to route transactions to various offer databases for validation. Smart routing and business rules may be used to determine which marketing partner or provider to route offer validations to. Promotion verifications and validations may be performed using database 132, a marketing partner's database, or a combination thereof.

Also provided is a customer aggregation database. The customer aggregation database aggregates data across different types of merchant cards, loyalty accounts, or discount programs to create customer profiles. These profiles may be used for creating analytics and performing targeted customer profiling across these different cards, accounts, and programs, even if they originate from different providers.

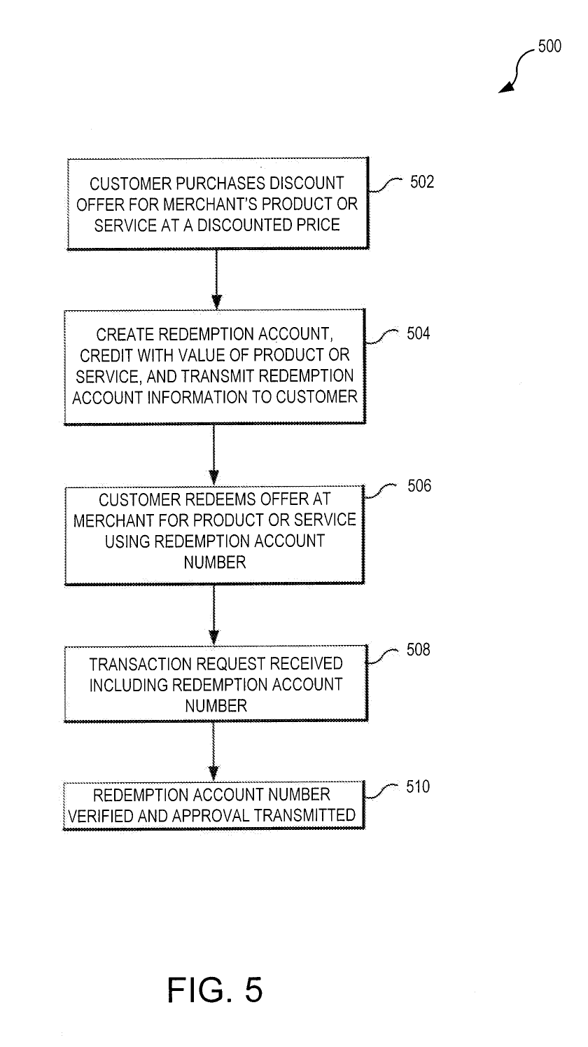

FIG. 5 illustrates method 500 which provides an alternate set of exemplary operations for processing purchase and redemption of an offer utilizing a redemption account. A customer purchases a discount offer using a credit card account number (step 502). The credit card processor debits the customer's credit card account for the purchase of the offer and creates a redemption account (step 504). The redemption account may be a gift card, a gift card account, a prepaid check card, an open loop prepaid card, a voucher account, a debit account, or other account associated with a credit or documentation reflecting the purchased discount offer. The redemption account will be validated when processed by the merchant. In some cases, the redemption account will be created such that it will be valid only at a particular merchant and invalid at any other merchant. In this way, the redemption account may only be used at the merchant associated with the purchased discount offer.

At step 506, the customer redeems the offer at the merchant using the redemption account number. The redemption account number may be provided to the merchant and processed in a manner similar to a typical credit or debit card transaction. The merchant may not even be aware that the redemption account being processed is not a typical credit or debit account. Alternatively, the redemption account may be processed in a manner which differs from that of typical credit and debit card transactions.

At step 508, a transaction request including the redemption account number is received by the payment processing system from the merchant. The payment processing system verifies the redemption account number and any other conditions required for its usage. Other conditions may include use at particular merchant, use for a particular product or service, use before an expiration date, a minimum transaction amount, a maximum transaction amount, or other conditions.

Finally, if the verification steps are satisfied, an approval for the transaction is transmitted to the merchant (step 510). This approval is an indication to the merchant that the merchant's account will be credited for the transaction. As discussed previously, the merchant's account will not get credited for the full amount in most cases as credits are typically issued to other entities involved with the publishing and sale of the discount offer and the processing of the transaction. Responsive to the transaction, the redemption account may also be debited, adjusted, closed, or canceled.

In another exemplary embodiment, a purchased offer is issued in the form of an mVoucher. An mVoucher is a virtual ValueLink prepaid account which enables redemption at all merchants using the ValueLink system. The publisher, in addition to sending a credit card authorization transaction for the purchase of the deal, sends a message to generate an mVoucher for the appropriate value. The mVoucher number will be returned to the purchasing site or transmitted to the customer. The customer takes the mVoucher to the merchant when they wish to redeem. The merchant hand keys the mVoucher number (or scans a barcode) at the POS terminal. The mVoucher is marked as redeemed and the approved message is sent back to the POS.

In another exemplary embodiment, payment authorization messages from the payment processor are routed to an offers engine. The offers engine could be associated with the credit card processor or with another entity. The decision to route could be based on the merchant being flagged as ‘offer-enabled’ in their merchant master file and acknowledging the potential transaction latency for all credit card authorizations. After determining the value of the offer from the offer engine, the front-end updates the transaction total and if any balance remains forwards the transaction through a standard authorization process. The message then follows a typical transaction process flow back to the POS with an approval/declined message and the adjusted transaction total and discount amounts. This option requires changes to the POS and authorization message specification to be able to display the offer amount and the adjusted credit card transaction amount.

In another exemplary embodiment, the customer pays the full amount at the POS terminal using existing POS systems and the discount offer is applied in the form of a credit to the customer's credit card account. The credit is calculated while processing the merchant deposit transactions for settlement. Transactions associated with redemption of discount offers are processed through normal core processes, in that they are posted for the full amount signed for at the POS. All interchange and other fees are applied against the POS amount. However, additional processes are applied for offer enabled merchant activity to determine if a discount offer applies to the transaction. In this case, the customer may see two line items on their statement: one full price purchase and the discount amount as a credit. The merchant may see two transactions in their account as well: one for the full amount and another associated with settlement of the discount.

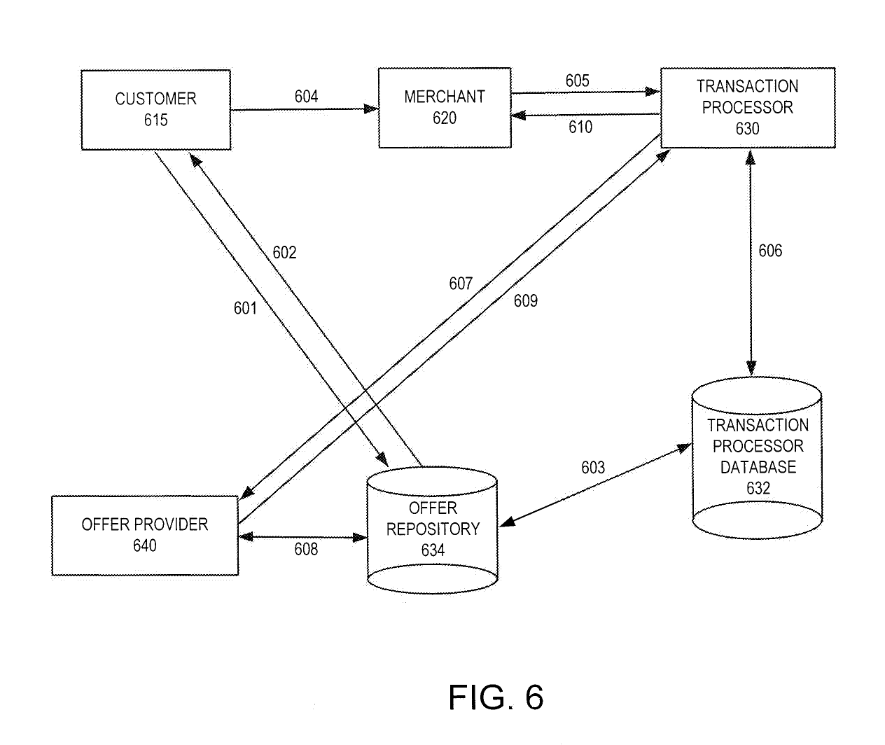

FIG. 6 illustrates an offer redemption process in which an offer provider is actively involved in the redemption process. In FIG. 6, at step 601, customer 615 enrolls in a branded offers program via a web interface and grants permission to communicate offers via email or text message from offer repository 634. Customer 614 is shopping in the geographical area of merchant 620. Customer 614 swipes his card at another participating merchant in the area. Based on the original transaction, an offer is identified in offer repository 634 for merchant 620. The offer is for a 30% discount at merchant 620. At step 602, the identified offer is pushed to customer 615 by offer provider 640 from offer repository 634 in order to leverage customer 615's geographical location. At step 603, offer provider pushes the customer card number and information about the offer to transaction processor database 632.

At step 604, the consumer acts on the offer, spends $100 at merchant 620, and provides the card for payment. At step 605, authorization for the purchase is routed to a front-end processing system of transaction processor 630. At step 606, transaction processor 630 queries transaction processor database 632 for offers associated with merchant 620 for which customer 615 may be eligible. Based on the query, transaction processor 630 determines that this transaction is eligible for the 30% discount which was received in the database at step 3 and also identifies another 5% online coupon. Transaction processor 630 executes priority logic to determine information including: the offer provider, whether the offer is pre-purchased, the expiration date, and the start date.

At step 607, the payment authorization is modified. If the 5% online coupon is prioritized, the offer provider is pinged for verification, the $100 transaction is changed to $95, and the outgoing offer indicator is set to “other offer”. Offer provider 640 recognizes the other offer indicator and does not process a redemption. In this case steps 608-610 are skipped. If the 30% offer is prioritized, offer provider 340 is pinged and the $100 authorization is sent to offer provider. At step 608, offer provider 340 routes the transaction to offer repository 634 and executes the appropriate authorization update. At step 609, offer provider 640 sends back the authorization transaction with offer information including one or more of an authorization amount, a discount, an offer trigger, a promo code, and receipt text. Transaction processor 630 recognizes translates the information provided by offer provider 640 and transmits the modified authorization to merchant 620 at step 610. Merchant 620 processes the transaction based on the modified authorization amount and the discount amount.

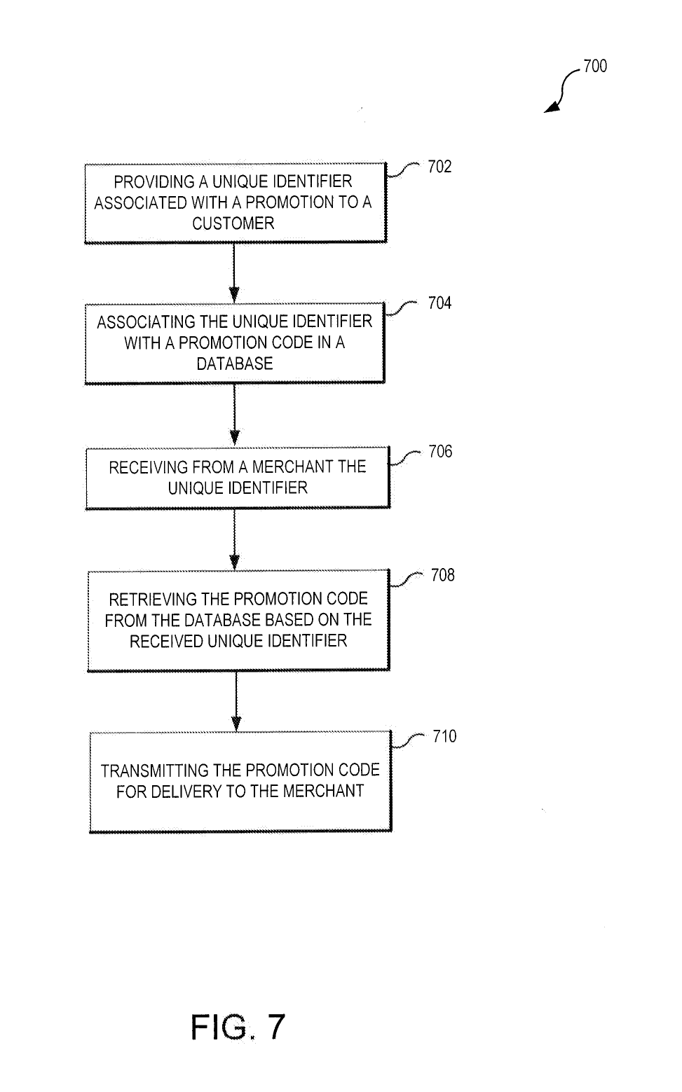

In another variation of the invention described herein, a customer may provide offer information directly to a merchant at the point of sale. However, the enhanced transaction processing features disclosed herein may still be used to assist the merchant in processing the promotion, including preventing duplicate use of a single instance of the promotion. FIG. 7 illustrates method 700 of processing promotions with a customer supplied promotion identifier. Method 700 is described with respect to operating environment 100 but implementation in other operating environments is possible.

In step 702 of method 700, a unique identifier associated with a promotion is provided to customer 110. The promotion is for a product or service offered by merchant 120. The unique identifier may be a series of numbers, a set of characters, a barcode, or any combination thereof. In one example, the unique identifier is provided to customer 110 in the form of a prepaid account with an account balance of zero. In other words, the account is created such that it will operate and can be processed as would a gift card or a prepaid account but does not have any funds associated with it. The prepaid account may be supplied in the form of a physical card with a unique account number in or on the card or may be a virtual account wherein an account number is provided to the customer by electronic means. The account number is associated with a particular discount or promotion. Promotion distributor 140 may provide the unique identifier directly to customer 110 through network 190, through transaction processor 130, through network 190, or some combination thereof.

In addition to providing the unique identifier to customer 110, promotion distributor 140 associates the unique identifier with a promotion code in database 132 at step 704. In one example, promotion distributor 140 provides the zero balance prepaid account to customer 110 and stores information in database 132 which associates the account number with a specific promotion or discount. Database 132 contains a code, a key, or other information which is necessary to apply the discount within a point-of-sale (POS) system of merchant 120. Many of these cards/accounts may be distributed to different customers and may even be associated with the same promotion or discount but each contains a unique identifier or account number enabling tracking of each individual instance of the promotion.

At a later point in time, customer 110 initiates a transaction with merchant 120 in which customer 110 wishes to redeem the discount or promotion. As part of this process, customer 110 provides the unique identifier to merchant 120. Merchant 120 transmits the unique identifier to transaction processor 130 at step 706. In one example, this unique identifier or account number is received by merchant 120 and processed in the same manner as a traditional gift card or prepaid card would be received and processed. In this example, the card has no balance associated with it, but will be used to identify the associated promotion or discount.

Continuing with method 700, transaction processor 130 receives the unique identifier or account number at step 708. Transaction processor 130 retrieves from database 132 the promotion or discount code which is associated with the received unique identifier at step 208. The promotion code which the merchant's POS system processes to determine or calculate the discount is then transmitted for delivery to the merchant step 210. Database 132 may then be modified to indicate that the unique identifier has been used to redeem the discount or promotion such that the same unique identifier cannot be used to redeem the discount or promotion again. This may be accomplished by making an entry in database 132 indicating that the unique identifier has been used or it may be accomplished by deleting the unique identifier or account number from a list of valid identifiers in database 132. Beneficially, each unique identifier or account number can be used only once. In addition, the customer is never in possession of the actual promotion code which is used to trigger the discount in the POS system. This significantly reduces the merchant's financial risk that the promotion code will be copied, duplicated, repeatedly used, or distributed to others. It also avoids placing additional burden on the merchant or the merchant's system to implement these functions. In some cases, this promotion validation process may be implemented using the existing interfaces that merchant 120 uses to transmit payment authorization requests to transaction processor 130.

In a variation of the example of method 700, each unique identifier or account number may be used multiple times, but not an unlimited number of times. For example, a promotion identifier of the type described above may be configured in database 132 such that it can be used five times. Each use is documented in database 132 and the number of remaining available uses is decremented. After the fifth use, it will no longer be recognized as a valid promotion identifier. The five uses may or may not be required to be exercised in conjunction with the same customer payment account.

In another variation of the example of method 700, the unique identifier or account number contains a particular set or subset of characters or numbers which uniquely identifies it as a promotion card. For example, the account number may start or end with a certain sequence of numbers such that it can easily be identified as a zero value account which is used to implement the promotion management features described above.

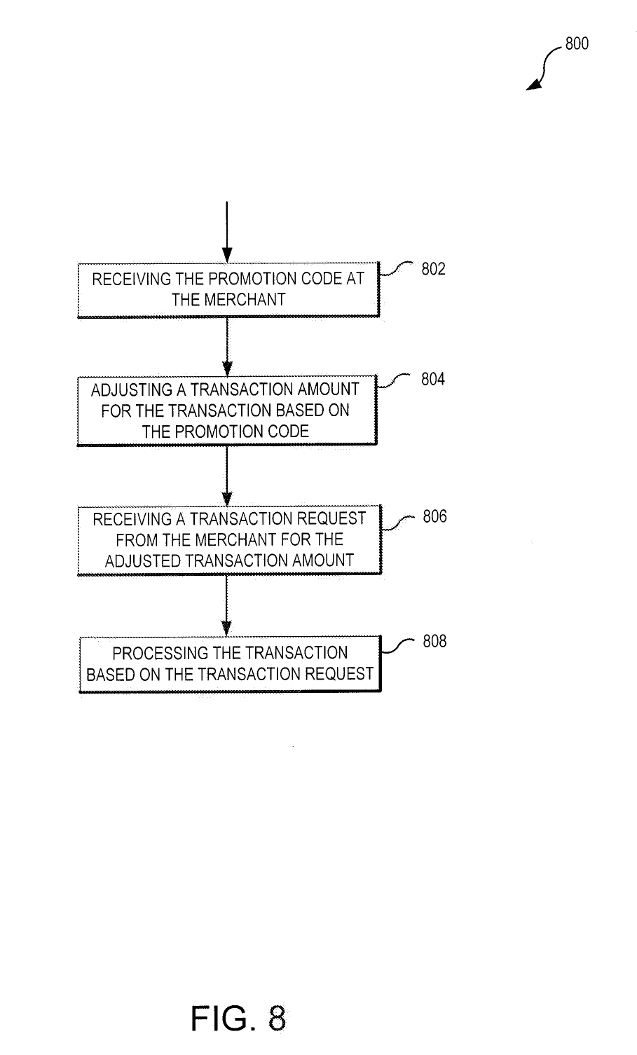

FIG. 8 illustrates method 800 of adjusting a transaction based on a promotion and is a continuation of method 700 of FIG. 7. Continuing where the description of FIG. 2 left off, merchant 120 receives the promotion code at step 802. At step 804, merchant 120 adjusts a transaction amount for the transaction based on the received promotion code. For example, the promotion code may be for 40% off of a purchase. The promotion code contains information which causes the merchant's POS system to reduce the transaction amount by the 40%. Many other types of discounts, promotions, or terms are possible. Customer 110 never has possession of the promotion code. In many cases, an employee of merchant 120 operating the POS system also does not have visibility to the promotion code. Once the adjusted transaction amount is determined, transaction processor 130 receives a transaction request from merchant 120 for the adjusted transaction amount at step 806. The transaction request may be of the type typically used for debit card or credit card transactions. The transaction request based on the adjusted amount is processed by transaction processor 130 at step 808. Beneficially, merchant 120 is able to process both the promotion and the payment for the remaining balance after the discount is applied using the same system and interface with transaction processor 130.

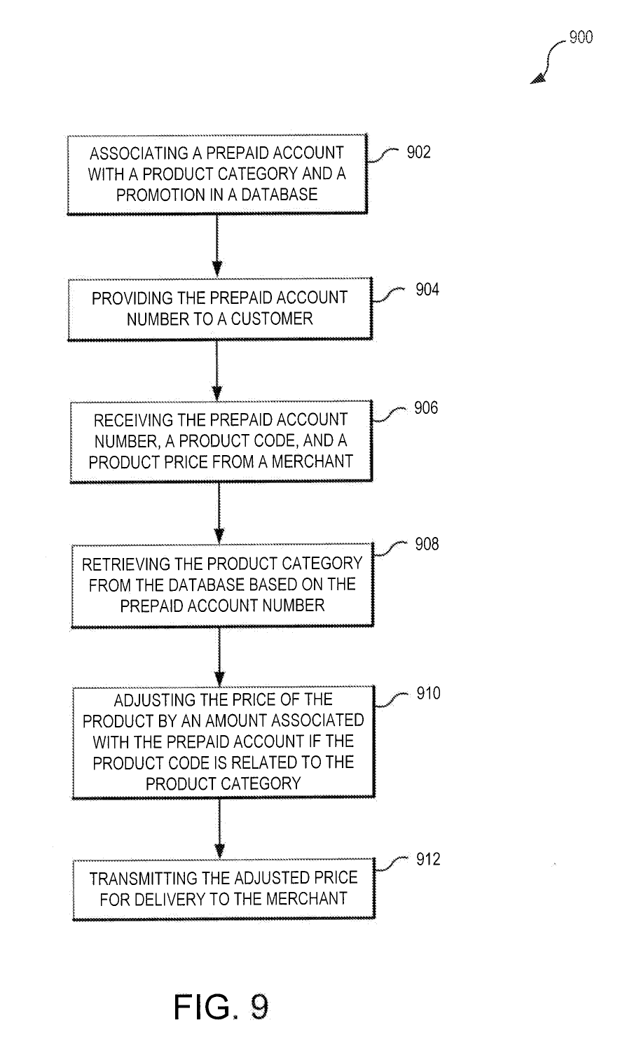

In another exemplary embodiment of the invention, the enhanced transaction processing system may be used to process offers and promotions that are implemented in the form of prepaid accounts. FIG. 9 illustrates method 900 of processing a promotion in conjunction with a prepaid account. Method 900 is described with respect to operating environment 100 of FIG. 1 although method 900 may be implemented in other operating environments or systems.

Merchant 120 desires to provide a promotion or reward to one or more customers in the form of a prepaid account which has a designated balance. In some cases, it may only be used toward a particular product or category of product. At step 902, a prepaid account is created and associated with merchant 120 and the product or product category in database 132. At step 904, the prepaid account number is provided to customer 110. The prepaid account number may be provided to customer 110 in the form of a card, in printed materials, or in some electronic format. In one example, merchant 120 is a department store wishing to provide one or more customers a prepaid card which has a balance of $40 to be used at the store towards purchase of a suit. The department store wishes to make sure that the customer uses the prepaid card toward the purchase of a suit and not simply redeem the $40 balance associated with the card for a less expensive item.

At step 906, the customer provides the prepaid account number or card to merchant 120 as part of a transaction. Merchant 120 transfers the account number to transaction processor 130 along with a product code for the product and a price of the product. Based on the account number, the product category associated with the promotion, which was stored at step 902, is retrieved from database 132. If the product code received from merchant 120 matches or is otherwise acceptably related to the product category received from database 132, the price of the product is adjusted based on the terms of the promotion at step 910. Then, the adjusted price is transmitted for delivery to merchant 120 at step 912. If a match or positive relationship between the product code and the stored product information is not determined, the price is not adjusted. Alternatively, the promotion or adjustment information may be transmitted to merchant 120 and the price adjustment may occur at merchant 120. Beneficially, merchant 120 is assured that the prepaid account can only be used by the customer for the selected category of products without having to rely on any employees or systems of merchant 120 to perform this screening process.

In the example of method 900, the product category information stored in database 132 may alternately identify a single product or a group of specific products rather than an entire category of products. The steps of method 900 may be performed in a similar manner with respect to purchase of a service by customer 110.

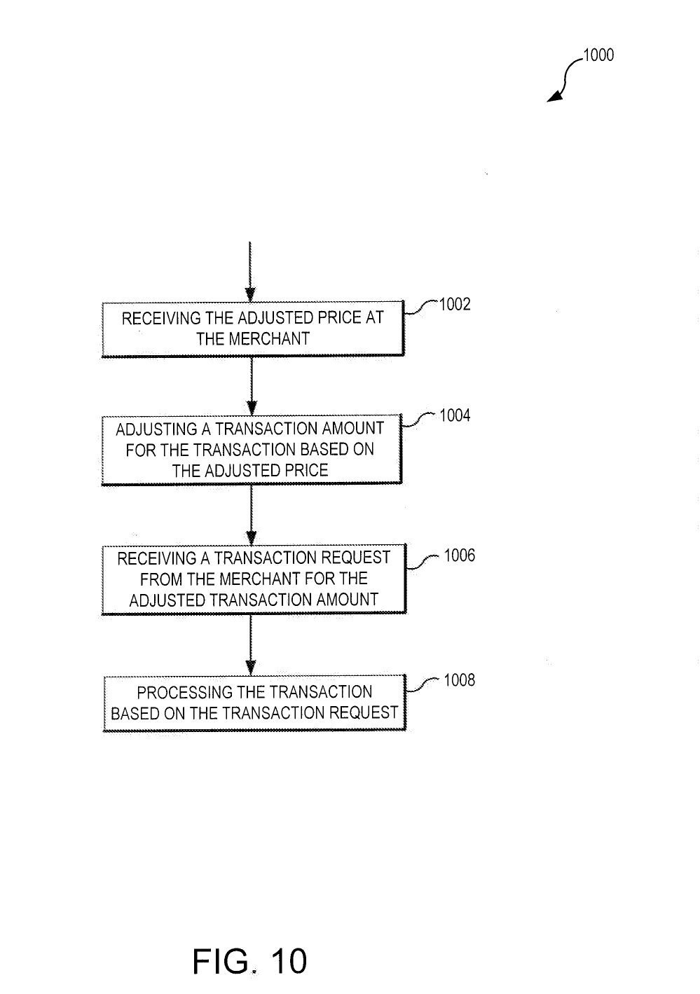

FIG. 10 illustrates method 1000 which is a method of adjusting a transaction based on a promotion and is an extension of method 900 of FIG. 9. Continuing where the description of FIG. 9 left off, merchant 120 receives the adjusted price from transaction processor 130 at step 1002. At step 1004, merchant 120 adjusts a transaction amount for the transaction based on the received adjusted price for the product. If the prepaid account covers the full cost of the transaction, no further steps may be necessary. If a non-zero transaction amount remains, customer 110 may pay the remaining amount by cash or check. Alternately, customer 110 may pay the remaining balance using a credit card, a debit card, a gift card, or another prepaid card. In this type of split tender transaction, merchant 120 transmits a transaction request to transaction processor 130 for the remaining amount based on the second form of payment offered by customer 110 at step 1006. The transaction request is processed by transaction processor 130 based on the remaining balance at step 1008. Beneficially, the described method allows merchant 120 to verify that the prepaid card is specifically valid for the selected product as well as process the prepaid card and the secondary form of payment using a single interface to transaction processor 130.

With respect to methods 900 and 1000, a situation may occur where the prepaid account has a balance which is greater than the cost of the product selected. For example, a prepaid account promotion provided by a restaurant may be valid for a free dessert up to $10. When the prepaid account information is transmitted to transaction processor 130, the product information is validated to make sure it belongs to the correct category. For instance, verifying that there is a dessert on the bill. In addition, transaction processor 130 compares the price of the product relative to the promotion. The total purchase may be for $85 and include several meals, but the most expensive dessert may only be $7. In this case, transaction processor 130 adjusts the discount or promotion amount to $7 based on the promotion and the product category and price information provided by the merchant even though the total available discount was $10 and the total transaction amount is more than $10.

The enhanced transaction processing systems and methods described herein may also be used to perform other processing steps on transactions. A set of rules may be established such that the charges for a transaction are distributed across multiple accounts. For personal financial accounting purposes, a customer may establish rules within his profile that cause a specified portion of each transaction to be charged to one account while any remaining amount of the transaction is charged to another account. Rules may also be established which set a maximum allowable transaction amount for transactions of certain types. For example, an employer who issues payment cards to employees may set up the accounts such that any transaction from a food provider will only be allowed up to a specified limit in order to enforce a meal expense limit. A secondary account may also be associated with the rules such that any overage is charged to another account, possibly the employee's own personal account.

In other cases, rules for processing the transactions may be associated with and/or established by third parties that are also associated with the transaction in some way. In one example, the system may be used to improve processing of charges where insurance coverage is involved. An insurance company may load the various procedure codes and allowed charges for the various medical procedures into the system. When a medical provider submits a transaction authorization, the additional information about the services performed and the breakdown of the associated charges may be submitted in conjunction with the transaction request. The transaction processing system uses submitted rules to determine what charges will be allowed based on the insurance coverage and any group agreements between the medical provider and the insurance company. The allowed charges are processed against an account of the insurance company. The disallowed charges, or overages, may be disallowed altogether or may be separately charged to an account of the customer.

Applying third party rules or performing additional analysis in conjunction with transaction processing, on a real-time or near real-time basis, allows the medical provider to be paid more quickly and allows the customer to be informed about what charges he or she will be responsible for in a more timely manner. The processing may also take into account deductibles or other accounting adjustments to the charges and allowed charges. The identification of the proper insurance provider and appropriate set of rules may be identified based on a customer identifier, such as the card number of the card used by the customer, such that the customer or medical provider are not required to submit any additional information in order to trigger the insurance adjustment and settlement process.

The systems and methods described herein may place various requirements upon merchants in order for them to be capable of utilizing the advanced features. In one case, a merchant may be required to agree to various legal requirements and/or contractual agreements regarding use or management of the additional information made available to merchants through the system. In addition, merchants may be required to use specific software, hardware, or POS terminal features in order to be compatible with various of the enhanced features described herein. Merchants satisfying a subset of these requirements may be capable of supporting a subset of these enhanced features. Also disclosed, is a merchant capability tool that describes which, if any, of the enhanced system features a merchant supports, or is capable of supporting. This tool enables offer publishers, offer promoters, or other parties to easily determine the capabilities of various merchants and/or the features of the system that these merchants support. An offer promoter may only be interested in pursuing deals with merchants that support particular capabilities because those features are necessary for the offer the promoter would like to provide or simply because the promoter prefers deals where some or all of the advanced features of the system may be used.

Offer providers and promoters receive benefit from the automated features and enhanced transaction processing features provided herein. Consequently, the transaction or payment processor may choose to charge offer promoters, offer providers, and offer processors (collectively referred to as users) for use of these functions and features. Also disclosed are rate tables for billing users based on the various features of the system that they use. Many different rate plans are possible. The rate plans could be based on a flat fee, a fee per promotion, a fee per customer, a fee per transaction, a fee based on transaction amount, a fee per feature exercised, or any combination. The system automatically tracks uses of various features for individual users of the system and generates bills for these users based on the tracked usage and their rate plan. Many other fee structures and agreements are possible including fee structures which share the fees across users and merchants where the system automatically allocates the fees and bill them among the various parties according to the agreements.

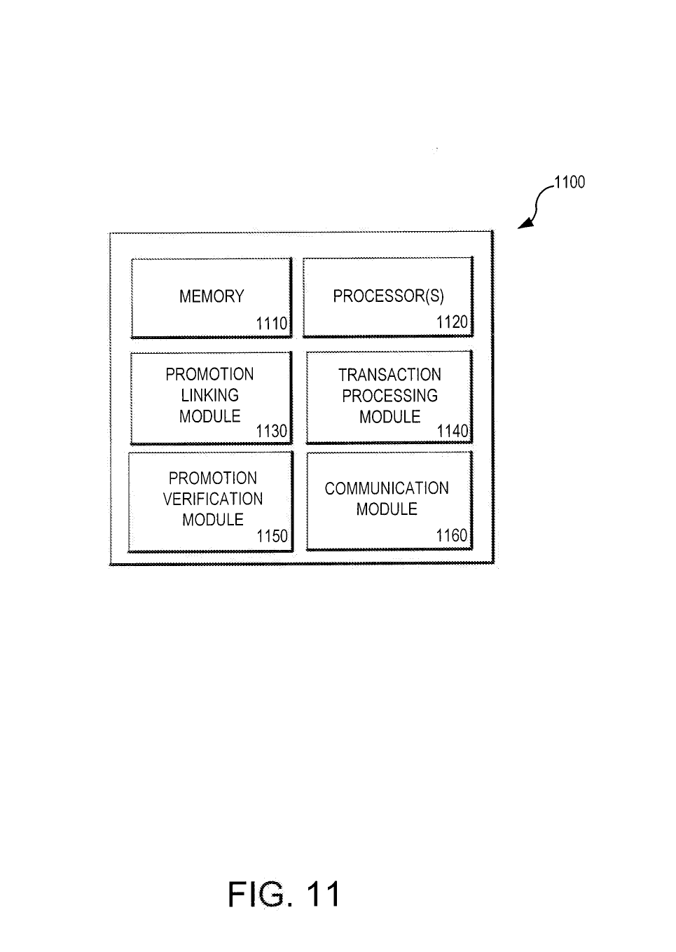

FIG. 11 illustrates payment processing system 1100 comprising components and modules with which some embodiments of the present invention may be utilized. Payment processing system 1100 includes memory 1110, one or more processors 1120, promotion linking module 1130, transaction processing module 1140, promotion verification module 1150, and communication module 1160. Other embodiments of the present invention may include some, all, or none of these modules and may include other modules, applications, and/or components. Still yet, some embodiments may incorporate two or more of these modules into a single module and/or associate a portion of the functionality of one or more of these modules with a different module. For example, in one embodiment, the functionality associated with promotion linking module 1130 and promotion verification module 1140 may be combined into a single promotion processing module. In another example, transaction processing module 1140 could be separated into a transaction request receiving module and a transaction authorization generation module.

Memory 1110 can be any device, mechanism, or populated data structure used for storing information. In accordance with some embodiments of the present invention, memory 1110 can encompass any type of, but is not limited to, volatile memory, nonvolatile memory, and dynamic memory. For example, memory 1110 can be random access memory, optical memory devices, magnetic media, floppy disks, magnetic tapes, hard drives, tape drives, SIMMs, SDRAM, DIMMs, RDRAM, DDR RAM, SODIMMS, erasable programmable read-only memories (EPROMs), electrically erasable programmable read-only memories (EEPROMs), compact disks, DVDs, and/or the like. In accordance with some embodiments, memory 1110 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 1110.

Memory 1110 may be used to store instructions for running one or more applications, sets of computer-readable software instructions, or modules on processor(s) 1120. For example, memory 1110 could be used in one or more embodiments to house all or some of the instructions needed to execute the functionality of promotion linking module 1130, transaction processing module 1140, promotion verification module 1150, and/or communication module 1160.

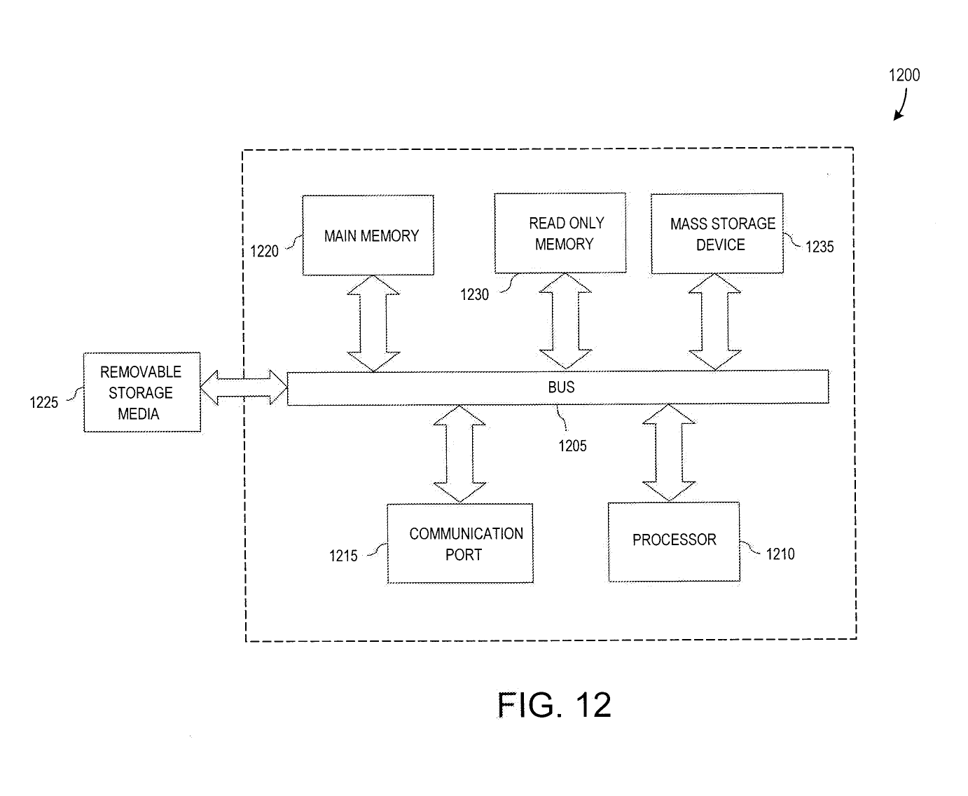

FIG. 12 illustrates computer system 1200 with which some embodiments of the present invention may be utilized. A variety of the steps and operations described herein may be performed by hardware components or may be embodied in non-transitory machine-executable instructions, which may be used to cause a general-purpose or special-purpose processor programmed with the instructions to perform the steps. Alternatively, the steps may be performed by a combination of hardware, software, and/or firmware. According to the present example, the computer system includes a bus 1205, at least one processor 1210, at least one communication port 1215, a main memory 1220, a removable storage media 1225, a read only memory 1230, and a mass storage device 1235.

Processor(s) 1210 can be any known processor, such as, but not limited to, an Intel® processor(s), AMD® processor(s), or Motorola® processor(s). Communication port 1215 can be any of a serial port, a parallel port, a 10/100 Ethernet port, or a Gigabit port using copper or fiber. Communication port 1215 may be chosen depending on a network such a Local Area Network (LAN), Wide Area Network (WAN), or any network to which the computer system 1200 connects.

Main memory 1220 can be any type of dynamic data storage device(s) commonly known in the art. Read only memory 1230 can be any static storage device(s) such as flash memory, Programmable Read Only Memory (PROM) chips, or other devices for storing static information such as instructions for processor 1210.

Mass storage 1235 can be used to store information and instructions. For example, hard disks such as SCSI drives, an optical disc, an array of disks such as RAID, or any other mass storage devices may be used.

Bus 1205 communicatively couples processor(s) 1210 with the other memory, storage, and communication blocks. Bus 1205 can be a PCI/PCI-X or SCSI based system bus depending on the storage devices used.

Removable storage media 1225 can be any kind of external hard-drives, floppy drives, thumb drive, IOMEGA® Zip Drives, Compact Disc-Read Only Memory (CD-ROM), Compact Disc-Re-Writable (CD-RW), Digital Video Disk-Read Only Memory (DVD-ROM).

The components described above are meant to exemplify some types of possibilities. In no way should the aforementioned examples limit the scope of the invention, as they are only exemplary embodiments.

Embodiments of the present invention include various steps and operations, which have been described above. A variety of these steps and operations may be performed by hardware components or may be embodied in non-transitory machine-executable instructions, which may be used to cause a general-purpose or special-purpose processor programmed with or executing the instructions to perform the steps. Alternatively, the steps may be performed by a combination of hardware, software, and/or firmware.

While, for convenience, embodiments of the present invention are described with reference to credit card transaction processing, embodiments of the present invention are equally applicable to various other systems and processes for processing financial transactions.

Also, for the sake of illustration, various embodiments of the present invention have herein been described in the context of computer programs, physical components, and logical interactions within modern computer networks. Importantly, while these embodiments describe various aspects of the invention in relation to modern computer networks and programs, the method and apparatus described herein are equally applicable to other systems, devices, and networks as one skilled in the art will appreciate. As such, the illustrated applications of the embodiments of the present invention are not meant to be limiting, but instead exemplary. Other systems, devices, and networks to which embodiments of the present invention are applicable include, but are not limited to, other types of communication and computer devices and systems. More specifically, embodiments are applicable to communication systems, services, and devices such as cell phone networks and compatible devices. In addition, embodiments are applicable to all levels of computing from the personal computer to large network mainframes and servers.

The present invention provides enhanced transaction processing features. While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof. Therefore, the above description should not be taken as limiting the scope of the invention, which is defined by the appended claims.

### TERMINOLOGY

Brief definitions of terms, abbreviations, and phrases used throughout this application are given below.

The terms ‘payment processor’ and ‘transaction processor’ are used herein to describe any entity that handles processing of credit cards, debit cards, prepaid cards, or electronic payments of various types on behalf of merchants, merchant banks, and/or customers and may include a front-end processor, a back-end processor, or both. The terms may be used interchangeably and any discussion of one may apply equally to the other. Similarly, the terms ‘payment processing system’ and ‘transaction processing system’ may be used interchangeably and any description or discussion of one may apply equally to the others.

The term ‘customer’ refers to any entity using one of the forms of payment described above to perform a transaction. A customer may be an individual, a company, a government, or any other entity desiring to conduct a financial transaction.

The terms ‘account,’ ‘customer account,’ and ‘payment account’ are used herein to describe any type of account a customer may use to provide payment for a transaction including a credit card account, a debit card account, a prepaid account, a bank account, a mobile wallet, or an account of another type that can be used to make electronic payments.

The terms ‘promotion,’ ‘offer,’ and ‘discount’ are used herein to describe any marketing method, element, or tool used to encourage or entice a customer to purchase a product or service or enter a transaction in some other way. These terms are used interchangeably herein and any description or discussion of one may apply equally to the others. The terms ‘redeem’ or ‘redemption’ may refer to any of promotions, offers, or discounts.

The terms ‘promoter,’ ‘advertiser,’ ‘promotion provider,’ ‘promotion marketer,’ ‘promotion publisher,’ and ‘promotion publisher’ are used herein to describe the various entities and functions associated with marketing, providing, and processing of promotions, offers, and discounts. These terms may describe separate entities and functions. However, one or more entities may perform any combination of these functions. In some cases, these functions may also be performed by a merchant, a payment processor, or a transaction processor.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to some embodiments,” “in the embodiments shown,” “in other embodiments,” “in one example,” “in some examples,” and the like generally mean the particular feature, structure, or characteristic following the phrase is included in at least one embodiment of the present invention, and may be included in more than one embodiment of the present invention. In addition, such phrases do not necessarily refer to the same embodiments or different embodiments.

If the specification states a component or feature “may”, “can”, “could”, or “might” be included or have a characteristic, that particular component or feature is not required to be included or have the characteristic.

The term “responsive” includes completely or partially responsive.

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, or a module can include one or more application programs.

The term “network” generally refers to a group of interconnected devices capable of exchanging information. A network may be as few as several personal computers on a Local Area Network (LAN) or as large as the Internet, a worldwide network of computers. As used herein “network” is intended to encompass any network capable of transmitting information from one entity to another. In some cases, a network may be comprised of multiple networks, even multiple heterogeneous networks, such as one or more border networks, voice networks, broadband networks, financial networks, service provider networks, Internet Service Provider (ISP) networks, and/or Public Switched Telephone Networks (PSTNs), interconnected via gateways operable to facilitate communications between and among the various networks.

What is claimed is:

1. A method comprising:
receiving a request from a merchant, at a computer of a payment processor, to authorize payment for a transaction using an account of a customer, wherein the request includes transaction information;
analyzing the transaction information based on a profile of the customer that is linked to the account in a database of the payment processor and based on data pertaining to at least one other related transaction;
generating, by the computer, a message about the transaction based on the analyzing; and
transmitting the message to a recipient.

2. The method of claim 1 wherein:
the profile indicates membership of the customer in a coalition of customers;
the at least one other related transaction is a transaction of another customer that belongs to the coalition; and
the recipient is at least one of the customers of the coalition.

3. The method of claim 2 wherein the message includes aggregated transaction information of two or more of the customers of the coalition.

4. The method of claim 2 wherein the message includes information indicating progress toward an objective of the coalition of customers.

5. The method of claim 2 wherein the message includes a promotion, a discount, or an offer directed to the coalition of customers.

6. The method of claim 1 wherein:
the profile identifies a group of merchants authorized to receive information about transactions of the customer; and
the recipient is a merchant of the group.

7. The method of claim 6 further comprising:
receiving information from the customer authorizing merchants to be in the group of merchants; and
updating the profile based on the received information.

8. The method of claim 6 wherein:
the merchants of the group are providers of complementary products; and
the message includes information about one or more items in the transaction.

9. The method of claim 1 wherein:
the transaction includes a redemption of a promotion;
the at least one other related transaction includes a transaction associated with purchase of the promotion prior to the transaction; and
the message includes an indication of the redemption of the promotion.

10. The method of claim 9 wherein the recipient is one or more of: a provider of the promotion, a publisher of the promotion, a marketer of the promotion, and the merchant.

11. The method of claim 9 wherein the message further includes a metric associated with the redemption.

12. The method of claim 11 wherein the metric includes at least one of: time elapsed between the purchase of the promotion and the redemption, a comparison of an amount of the transaction compared to amounts of other transactions of the customer, a comparison of the amount of the transaction to amounts of redemption transactions for the promotion associated with other customers, and a comparison of characteristics of the redemption to redemptions of other promotions.

13. The method of claim 1 wherein the message further includes predictive analytics of customer behavior based on the analyzing.

14. The method of claim 1 wherein the profile includes at least one monitored transaction characteristic and analyzing the transaction information based on the profile includes determining that the transaction includes the monitored transaction characteristic.

15. The method of claim 14 wherein the monitored transaction characteristic is one or more of: an item included in the transaction, a category of items associated with the transaction, an amount of the transaction, the merchant, and a category of merchant associated with the transaction.

16. The method of claim 14 wherein the monitored transaction characteristic is specified by a government agency and the government agency is the recipient of the message.

17. The method of claim 1 wherein the related transaction is a transaction conducted using another account of the customer and the profile includes information linking the account and the other account.

18. The method of claim 1 wherein the customer is the recipient and the message includes a promotion, an offer, or a discount related to the transaction.

19. A transaction processing system comprising:
a database;
a communication module configured to receive a request from a merchant to authorize payment for a transaction using a financial account of a customer, wherein the request includes transaction information; and
a processing module configured to:
analyze the transaction information based on a profile of the customer that is linked to the financial account in the database and based on data pertaining to at least one other related transaction;
generate an approval for the transaction in response to the request to authorize payment;
generate a notification about the transaction based on the analysis; and
wherein the communication module is further configured to:
transmit the approval to the merchant; and
transmit the notification to a recipient.

20. The transaction processing system of claim 19 wherein:
the profile indicates membership of the customer in a coalition of customers;
the at least one other related transaction is a transaction of another customer that belongs to the coalition; and
the recipient is at least one of the customers of the coalition.

21. The transaction processing system of claim 20 wherein the notification includes aggregated transaction information of two or more of the customers of the coalition and indicates progress toward an objective of the coalition of customers.

22. The transaction processing system of claim 20 wherein the notification includes a promotion, a discount, or an offer directed to the coalition of customers.

23. The transaction processing system of claim 19 wherein:
the profile identifies a group of merchants authorized to receive information about transactions of the customer; and
the recipient is a merchant of the group.

24. The transaction processing system of claim 23 wherein:
the communication module is further configured to receive information from the customer authorizing merchants to be in the group of merchants; and
the processing module is further configured to update the profile based on the received information.

25. The transaction processing system of claim 23 wherein:
the merchants of the group are providers of products that are complimentary to products of other merchants of the group; and
the notification includes information about one or more items in the transaction.

26. The transaction processing system of claim 19 wherein:
the transaction includes a redemption of a promotion;
the at least one other related transaction includes a transaction associated with a purchase of the promotion prior to the transaction; and
the notification includes an indication of the redemption of the promotion.

27. The transaction processing system of claim 26 wherein the notification further includes a characteristic of the redemption based on at least one of: time elapsed between the purchase of the promotion and the redemption, a comparison of an amount of the transaction compared to amounts of other transactions of the customer, a comparison of the amount of the transaction to amounts of redemption transactions for the promotion associated with other customers, and a comparison of characteristics of the redemption to redemptions of other promotions.

28. The transaction processing system of claim 19 wherein the financial account is a credit account, a debit account, or a prepaid account.

29. The transaction processing system of claim 19 wherein the profile includes at least one monitored transaction characteristic and analyzing the transaction information based on the profile includes determining that the transaction includes the monitored transaction characteristic.

30. The transaction processing system of claim 29 wherein the monitored transaction characteristic is one or more of: an item included in the transaction, a category of items associated with the transaction, a time of the transaction, the merchant, and a category of merchant associated with the transaction.

31. The transaction processing system of claim 30 wherein the monitored transaction characteristic is specified by a government agency and the government agency is the recipient of the notification.

32. The transaction processing system of claim 19 wherein the related transaction is a transaction conducted using another financial account of the customer and the profile includes information linking the financial account and the other financial account.

33. A non-transitory computer-readable medium comprising instructions that, when executed by one or more computer processors of a payment processing system, direct the one or more computer processors to:
receive a request from a merchant to authorize payment for a transaction using a financial account of a customer, wherein the request includes transaction information;
analyze the transaction information based on a profile of the customer that is linked to the financial account in a database of the payment processing system and based on data pertaining to at least one other transaction;
generate a message related to the transaction based on the analysis; and
transmit the message to a recipient.

34. The medium of claim 33 wherein:
the profile indicates membership of the customer in a customer group;
the at least one other transaction is a transaction of another customer of the customer group;
the message indicates progress toward a goal of the customer group; and
the recipient is all members of the customer group.

35. The medium of claim 33 wherein:
the profile identifies a group of merchants permitted to receive information about transactions of the customer; and
the recipient is a merchant of the group.

36. The medium of claim 35 wherein the instructions further direct the one or more computer processors to update the profile based on information received from the customer permitting a selected merchant to be in the group of merchants.

37. The medium of claim 33 wherein:
the transaction includes redemption of a promotion;
the at least one other transaction is a purchase of the promotion prior to the transaction; and
the message indicates redemption of the promotion.

38. The medium of claim 37 wherein the message further includes a metric associated with the redemption, the metric including at least one of: time elapsed between the purchase of the promotion and the transaction, a comparison of an amount of the transaction compared to amounts of other transactions of the customer, a comparison of the amount of the transaction to amounts of redemption transactions for the promotion associated with other customers, a comparison of characteristics of the redemption to redemptions of other promotions, and a ranking of the customer compared to other customers.

39. The medium of claim 33 wherein the profile includes at least one monitored transaction characteristic and analyzing the transaction information based on the profile includes determining that the transaction includes the monitored transaction characteristic, wherein the monitored transaction characteristic is one or more of: an item included in the transaction and a category of items associated with the transaction.

40. The medium of claim 39 wherein the monitored transaction characteristic is specified by a government agency and the government agency is the recipient of the message.

41. The medium of claim 33 wherein the at least one other transaction is a transaction conducted using another financial account of the customer and the profile includes information linking the financial account and the other financial account.
